(19) United States
(12) Patent Application Publication
(10) Pub. No.: US 2019/0161597 A1
(43) Pub. Date: May 30, 2019

(54) PLASTICIZER COMPOSITION

(71) Applicant: BASF SE, Ludwigshafen am Rhein (DE)

(72) Inventors: MATTHIAS PFEIFFER, Ludwigshafen am Rhein (DE); Boris BREITSCHEIDEL, Ludwigshafen am Rhein (DE); Axel GRIMN, Ludwigshafen am Rhein (DE); Herbert MORGENSTERN, Ludwigshafen am Rhein (DE)

(21) Appl. No.: 16/321,919

(22) PCT Filed: Jul. 27, 2017
(86) PCT No.: PCT/EP2017/068978

§ 371 Date: Jan. 30, 2019

(30) Foreign Application Priority Data
Aug. 1, 2016 (EP) 16182126.9

(51) Int. Cl. C08K 5/12; C08K 5/00; C08L 27/06

(52) U.S. Cl. CPC C08K 5/12; C08K 5/0016; C08L 2203/16; C08K 2201/014; C08L 27/06

(57) ABSTRACT

A plasticizer composition comprising
(a) at least one compound of the general formula (I),

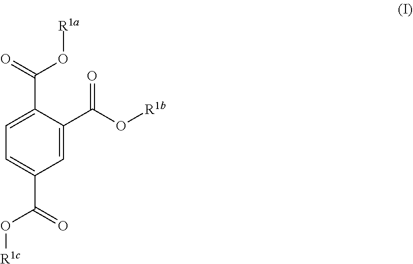

in which
R^{1a}, R^{1b} and R^{1c} are each independently C₃- to C₅-alkyl
(b) at least one compound of the general formula (II),

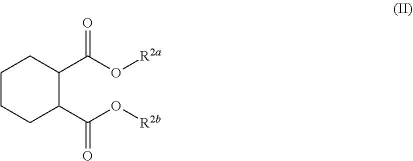

in which
R^{2a} and R^{2b} are each independently C₇- to C₁₂-alkyl.

### BACKGROUND OF THE INVENTION

The present invention relates to a plasticizer composition comprising at least one trialkyl trimellitate and at least one 1,2-cyclohexanedicarboxylic acid ester, to molding compositions comprising at least one polymer and one such plasticizer composition, to plastisols comprising at least one polymer and one such plasticizer composition and to the use of these plasticizer compositions in molding compositions and plastisols.

### PRIOR ART

Polyvinyl chloride (PVC), in terms of amount, is one the most commonly produced plastics. PVC is usually a hard and brittle plastic up to ca. 80° C., which is used as unplasticized PVC (PVC-U) by adding thermal stabilizers and other additives. By adding plasticizers, plasticized PVC (PVC-P) can be made, which may be used for many applications for which unplasticized PVC is unsuitable.

In general, the use of plasticizers serves to lower the processing temperature of plastics and to increase the elasticity thereof.

In this case, it is desirable that the plasticizers have a high compatibility with the plasticized plastic, that is to say that they do not leak out of the plasticized plastic, or only relatively slowly, and/or they are largely of no toxicological concern.

Plasticizers are typically used in other plastics besides PVC. Other plastics can be, for example, polyvinyl butyral (PVB), homo- or copolymers of styrene, polyacrylates, polysulfides or thermo-plastic polyurethanes (TPU).

Various plasticizers for plastics, for PVC for example, are disclosed in the prior art.

For instance, EP 1354867 B1 discloses mixtures of isononyl benzoates in combination with phthalic acid dialkyl esters and/or adipic acid dialkyl esters and/or cyclohexanedicarboxylic acid alkyl esters which, according to the description, may be used as plasticizer for PVC.

Disclosed according to the description of EP 1415978 B1 are mixtures of isodecyl benzoates in combination with phthalic acid dialkyl esters and/or adipic acid dialkyl esters and/or cyclohex-anedicarboxylic acid dialkyl esters, which may be used as plasticizer for PVC.

According to EP 1873198 A1, mixtures of trialkyl esters of trimellitic acid and aryl esters of trimellitic acid are suitable as plasticizers for plastics such as PVC. According to the description, a low dissolution temperature and volatility is attributed to the mixtures disclosed. Plastics comprising the mixture disclosed may also comprise further plasticizers.

A plasticizer composition for plastics, for example for PVC, should be found which imparts good mechanical properties to the plastics plasticized therewith. The plasticizer composition should also have good gelling properties and high compatibility with the plastics to be plasticized and be of no toxicological concern. In addition, the plasticizer composition should exhibit low volatility, both during processing and during use of the end products.

This object is achieved by a plasticizer composition comprising

(a) at least one compound of the general formula (I),

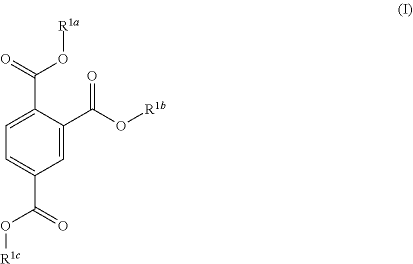

in which
R^{1a}, R^{1b} and R^{1c} are each independently C₃- to C₅-alkyl

(b) at least one compound of the general formula (II),

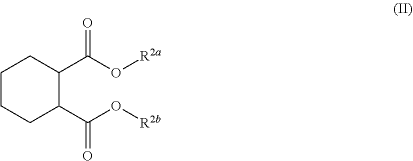

in which
R^{2a} and R^{2b} are each independently C₇- to C₁₂-alkyl.

A subject matter of the disclosure is the use of the disclosed plasticizer composition as plasticizer for plastics.

Also a subject matter of the disclosure is the use of the disclosed plasticizer composition as plasticizer for plastisols.

A subject matter of the disclosure is likewise a molding composition comprising at least one polymer and the disclosed plasticizer composition.

Furthermore, a subject matter of the disclosure is a plastisol comprising at least one polymer and the disclosed plasticizer composition.

A subject matter of the present disclosure is also the use of a molding composition comprising at least one polymer and the disclosed plasticizer composition for producing moldings and films.

A subject matter of the present disclosure is also the use of a plastisol comprising at least one polymer and the disclosed plasticizer composition for producing moldings and films.

Moldings and films comprising the disclosed plasticizer composition are also a subject matter of the present disclosure.

### DESCRIPTION OF THE INVENTION

In the context of the present disclosure, the abbreviation phr (parts per hundred resin) stands for parts by weight per hundred parts by weight polymer.

The percentage by weight figures, unless stated to the contrary, refer to the respective total weight.

A mixture is any desired mixture of two or more, for example a mixture may comprise two to five or more. A mixture may also comprise any large number.

In the context of the present disclosure, a gellating aid is a plasticizer or a mixture of different plasticizers, which is characterized in that the dissolution temperature of the plasticizer or the mixture of different plasticizers is at most 125° C., In accordance with DIN 53408 (06/1967).

A compound of the general formula (I) can be:

I.1 is tri(n-propyl) 1,2,4-benzenetricarboxylate

I.2 is tri(iso-propyl) 1,2,4-benzenetricarboxylate

I.3 is tri(n-butyl) 1,2,4-benzenetricarboxylate

I.4 is tri(isobutyl) 1,2,4-benzenetricarboxylate

I.5 is tri(n-pentyl) 1,2,4-benzenetricarboxylate

I.6 is tri(2-methylbutyl) 1,2,4-benzenetricarboxylate

I.7 is tri(3-methylbutyl) 1,2,4-benzenetricarboxylate

A compound of the general formula (II) can be:

II.1 is di(2-ethylhexyl) 1,2-cyclohexanedicarboxylate

II.2 is di(isononyl) 1,2-cyclohexanedicarboxylate

II.3 is di(2-propylheptyl) 1,2-dicarboxylic acid dicarboxylate

A polymer is a plastic. A polymer can be an elastomer or a thermoplastic. A thermoplastic is generally thermoplastically processable.

A thermoplastic can be, for example:

TP.1 is a homo- or copolymer which comprises, in polymerized form, at least one monomer selected from C₂-C₁₀ monoolefins, for example ethylene, propylene, 1,3-butadiene, 2-chloro-1,3-butadiene, vinyl alcohols or C₂-C₁₀-alkyl esters thereof, vinyl acetate, vinyl chloride, vinylidene chloride, vinylidene fluoride, tetrafluoroethylene, glycidyl acrylate, glycidyl methacrylate, acrylates or methacrylates with alcohol components of branched or unbranched C₁-C₁₀-alcohols, vinylaromatics, for example styrene, (meth)acrylonitrile, α,β-ethylenically unsaturated mono- or dicarboxylic acids, and maleic anhydride.

TP.2 is a polyvinyl ester

TP.3 is a polycarbonate

TP.4 is a polyether

TP.5 is a polyether ketone

TP.6 is a thermoplastic polyurethane

TP.7 is a polysulfide

TP.8 is a polysulfone

TP.9 is a polyester

TP.10 is a polyalkylene terephthalate

TP.11 is a polyhydroxyalkanoate

TP.12 is a polybutylene succinate

TP.13 is a polybutylene succinate adipate

TP.14 is a polyacrylate having the same or different alcohol residues from the group of C₄- to C₈-alcohols such as butanol, hexanol, octanol, 2-ethylhexanol

TP.15 is a polymethyl methacrylate

TP.16 is a methyl methacrylate-butyl acrylate copolymer

TP.17 is an acrylonitrile-butadiene-styrene copolymer

TP.18 is an ethylene-propylene copolymer

TP.19 is an ethylene-propylene-diene copolymer

TP.20 is a polystyrene

TP.21 is a styrene-acrylonitrile copolymer

TP.22 is an acrylonitile-styrene-acrylate

TP.23 is a styrene-butadiene-methyl methacrylate copolymer

TP.24 is a styrene-maleic anhydride copolymer

TP.25 is a styrene-methacrylic acid copolymer

TP.26 is a polyoxymethylene

TP.27 is a polyvinyl alcohol

TP.28 is a polyvinyl acetate

TP.29 is a polyvinyl butyral

TP.30 is a polyvinyl chloride

TP.31 is a polycaprolactone

TP.32 is polyhydroxybutyric acid

TP.33 is polyhydroxyvaleric acid

TP.34 is polylactic acid

TP.35 is ethylcellulose

TP.36 is cellulose acetate

TP.37 is cellulose propionate

TP.38 is cellulose acetate/butyrate

“X” as entry in a table means that this combination is present.

In general, polyvinyl chloride is obtained by homopolymerization of vinyl chloride. The polyvinyl chloride present in the disclosed molding composition can be produced, for example, by suspension polymerization or bulk polymerization. The polyvinyl chloride present in the disclosed plastisol can be produced, for example, by microsuspension polymerization or bulk polymerization. The preparation of polyvinyl chloride by polymerization of vinyl chloride and production and composition of plasticized polyvinyl chloride are described, for example, in “Becker/Braun, Kunststoff-Handbuch [Plastics Handbook], Volume 2/1: Polyvinylchloride”, 2nd edition, Carl Hanser Verlag, Munich.

The K value, which characterizes the molar mass of the polyvinyl chloride and is determined in accordance with DIN EN 1628-2 (November 1999), for the polyvinyl chloride plasticized with the disclosed plasticizer composition is usually in the range from 57 to 90, preferably in the range from 61 to 85 and particularly preferably in the range from 64 to 80.

Advantageously, the present plasticizer composition is characterized by a high compatibility with the plastic to be plasticized. In addition, the gelling characteristics of the plastics plasticized therewith can be positively influenced by the present plasticizer composition. Furthermore, the present plasticizer composition is characterized by low volatility, both during processing and during use of the end products. Likewise, the present plasticizer composition has an advantageous effect on the mechanical properties of the plastics plasticized therewith.

Good mechanical properties can be reflected, for example, in high elasticity of the plasticized plastics. A measure of elasticity of plasticized plastics is the Shore A hardness. The lower the Shore A hardness, the higher the elasticity of the plasticized plastics.

A measure of good gelling properties can be a low dissolution temperature/gelling temperature.

The compatibility (permanence) of plasticizers in plasticized plastics characterizes to which extent plasticizers tend to bleed during use of the plasticized plastics and as a result of which the use properties of the plastics are impaired.

Low volatility during processing can be reflected, for example, by low process volatility.

Low volatility during use of the end product can be reflected, for example, by low film volatility.

Compounds of the general formula (I) have a comparable or lower dissolution temperature than bis(2-ethylhexyl) phthalate (125° C.) in accordance with DIN 53408 (June/1967). Owing to their dissolution temperature and their plasticizer properties, compounds of the general formula (I) can be used as gellating aids.

In general, the dissolution temperature/gelling temperature refers to the minimum temperature at which a substantially homogeneous phase between polymer and plasticizer is formed.

The subject matter of the present disclosure is a plasticizer composition comprising at least one compound of the general formula (I) and at least one compound of the general formula (II).

In a compound of the general formula (I), R^{1a}, R^{1b} and R^{1c} are each independently C₃- to C₅-alkyl. C₃- to C₅-alkyl can be straight-chain or branched. For example, C₅- to C₅-alkyl can be n-propyl, isopropyl, n-butyl, isobutyl, n-pentyl, 2-methylbutyl or 3-methylbutyl. It may be more preferable that R^{1a}, R^{1b} and R^{1c} are each independently C₄-alkyl. C₄-alkyl can be straight-chain or branched. For example, C₄-alkyl can be n-butyl or isobutyl.

Even if R^{1a}, R^{1b} and R^{1c} in a compound of the general formula (I) are generally Independent of each other, R^{1a}, R^{1b} and R^{1c} are generally identical.

The plasticizer composition disclosed comprises at least one compound of the general formula (I). The plasticizer composition disclosed can accordingly also comprise a mixture of compounds of the general formula (I).

The plasticizer composition may comprise, for example, a mixture of compounds of the general formula (I), selected from I.1, I.2, I.3, I.4, I.5, I.6 and I.7.

In a compound of the general formula (II), R^{2a} and R^{2b} are each Independently C₇- to C₁₂-alkyl. C₇- to C₁₂-alkyl can be straight-chain or branched. For example, C₇- to C₁₂-alkyl can be n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl, 2-propylhexyl, n-decyl, isodecyl, 2-propylheptyl, n-undecyl, isoundecyl or n-dodecyl, isododecyl. It may be preferable that R^{2a} and R^{2b} are each Independently C₈- to C₁₁-alkyl. C₈ to C₁₁-alkyl can be straight-chain or branched. For example, C₈- to C₁₁-alkyl can be n-octyl, n-nonyl, isononyl, 2-ethylhexyl, isodecyl, 2-propylheptyl, n-undecyl or isoundecyl.

Even if R^{2a} and R^{2b} in a compound of the general formula (II) are generally independent of each other, R^{2a} and R^{2b} are generally identical.

The plasticizer composition disclosed comprises at least one compound of the general formula (II). The plasticizer composition disclosed can accordingly also comprise a mixture of compounds of the general formula (II).

The plasticizer composition disclosed may comprise, for example, a mixture of compounds of the general formula (II), selected from II.1, II.2, and II.3.

A plasticizer composition may comprise, for example:

| | Dialkyl | | |
|---|---|---|---|
| | cyclohexane- | | |
| | 1,2-dicarboxylate | | |
| Trialkyl trimellitate | II.1 | II.2 | II.3 |
| I.1 | X | | |
| I.1 | | X | |
| I.1 | | | X |
| I.1 | X | X | |
| I.1 | X | | X |
| I.1 | | X | X |
| I.1 | X | X | X |
| I.2 | X | | |
| I.2 | | X | |
| I.2 | | | X |
| I.2 | X | X | |
| I.2 | X | | X |
| I.2 | | X | X |
| I.2 | X | X | X |
| I.3 | X | | |
| I.3 | | X | |
| I.3 | | | X |
| I.3 | X | X | |
| I.3 | X | | X |
| I.3 | | X | X |
| I.3 | X | X | X |
| I.4 | X | | |
| I.4 | | X | |
| I.4 | | | X |
| I.4 | X | X | |
| I.4 | X | | X |
| I.4 | | X | X |
| I.4 | X | X | X |
| I.5 | X | | |
| I.5 | | X | |
| I.5 | | | X |
| I.5 | X | X | |
| I.5 | X | | X |
| I.5 | | X | X |
| I.5 | X | X | X |
| I.6 | X | | |
| I.6 | | X | |
| I.6 | | | X |
| I.6 | X | X | |
| I.6 | X | | X |
| I.6 | | X | X |
| I.6 | X | X | X |
| I.7 | X | | |
| I.7 | | X | |
| I.7 | | | X |
| I.7 | X | X | |
| I.7 | X | | X |
| I.7 | | X | X |
| I.7 | X | X | X |

a mixture of compounds I.1 to I.7 and compound II.1

or,

a mixture of compounds I.1 to I.7 and compound II.2

or,

a mixture of compounds I.1 to I.7 and compound II.3

or,

a mixture selected from compound I.1, I.2, I.3, I.4, I.5, I.6 and I.7 and a mixture selected from compound II.1, II.2 and II.3.

The content of at least one compound of the general formula (I) in the plasticizer composition disclosed is generally 5 to 70 percent by weight. It may be preferable that the content is 8 to 70 percent by weight and more preferably 10 to 70 percent by weight. The content of at least one compound of the general formula (I) in the plasticizer composition disclosed can be, for example, 15, 20, 25, 30, 35, 40, 45, 50, 55, 60, or 65 percent by weight.

The content of at least one compound of the general formula (II) in the plasticizer composition disclosed is generally 30 to 95 percent by weight. It may be preferable that the content is 30 to 92 percent by weight and more preferably 30 to 90 percent by weight. The content of at least one compound of the general formula (II) in the plasticizer composition disclosed can be, for example, 35, 40, 45, 50, 55, 60, 65, 70, 75, 80, or 85 percent by weight.

The subject matter of the disclosure can therefore be a plasticizer composition comprising 5 to 70 percent by weight of at least one compound of the general formula (I) and comprising 30 to 95 percent by weight of at least one compound of the general formula (II). It may be preferable that a plasticizer composition comprises 8 to 70 percent by weight of at least one compound of the general formula (I) and 30 to 92 percent by weight of at least one compound of the general formula (II). It may be more preferable that a plasticizer composition comprises 10 to 70 percent by weight of at least one compound of the general formula (I) and 30 to 90 percent by weight of at least one compound of the general formula (II).

In the context of the disclosure, a plasticizer composition can comprise,

| | Dialkyl | | |
|---|---|---|---|
| | cyclohexane- | | |
| | 1,2-dicarboxylate | | |
| | 30% to 95% | | |
| | by weight of | | |
| Trialkyl trimellitate | II.1 | II.2 | II.3 |
| 5 to 70% by weight of | X | | |
| I.1 | | | |
| 5 to 70% by weight of | | X | |
| I.1 | | | |
| 5 to 70% by weight of | | | X |
| I.1 | | | |
| 5 to 70% by weight of | X | X | |
| I.1 | | | |
| 5 to 70% by weight of | X | | X |
| I.1 | | | |
| 5 to 70% by weight of | | X | X |
| I.1 | | | |
| 5 to 70% by weight of | X | X | X |
| I.1 | | | |
| 5 to 70% by weight of | X | | |
| I.2 | | | |
| 5 to 70% by weight of | | X | |
| I.2 | | | |
| 5 to 70% by weight of | | | X |
| I.2 | | | |
| 5 to 70% by weight of | X | X | |
| I.2 | | | |
| 5 to 70% by weight of | X | | X |
| I.2 | | | |
| 5 to 70% by weight of | | X | X |
| I.2 | | | |
| 5 to 70% by weight of | X | X | X |
| I.2 | | | |
| 5 to 70% by weight of | X | | |
| I.3 | | | |
| 5 to 70% by weight of | | X | |
| I.3 | | | |
| 5 to 70% by weight of | | | X |
| I.3 | | | |
| 5 to 70% by weight of | X | X | |
| I.3 | | | |
| 5 to 70% by weight of | X | | X |
| I.3 | | | |
| 5 to 70% by weight of | | X | X |
| I.3 | | | |
| 5 to 70% by weight of | X | X | X |
| I.3 | | | |
| 5 to 70% by weight of | X | | |
| I.4 | | | |
| 5 to 70% by weight of | | X | |
| I.4 | | | |
| 5 to 70% by weight of | | | X |
| I.4 | | | |
| 5 to 70% by weight of | X | X | |
| I.4 | | | |
| 5 to 70% by weight of | X | | X |
| I.4 | | | |
| 5 to 70% by weight of | | X | X |
| I.4 | | | |
| 5 to 70% by weight of | X | X | X |
| I.4 | | | |
| 5 to 70% by weight of | X | | |
| I.5 | | | |
| 5 to 70% by weight of | | X | |
| I.5 | | | |
| 5 to 70% by weight of | | | X |
| I.5 | | | |
| 5 to 70% by weight of | X | X | |
| I.5 | | | |
| 5 to 70% by weight of | X | | X |
| I.5 | | | |
| 5 to 70% by weight of | | X | X |
| I.5 | | | |
| 5 to 70% by weight of | X | X | X |
| I.5 | | | |
| 5 to 70% by weight of | X | | |
| I.6 | | | |
| 5 to 70% by weight of | | X | |
| I.6 | | | |
| 5 to 70% by weight of | | | X |
| I.6 | | | |
| 5 to 70% by weight of | X | X | |
| I.6 | | | |
| 5 to 70% by weight of | X | | X |
| I.6 | | | |
| 5 to 70% by weight of | | X | X |
| I.6 | | | |
| 5 to 70% by weight of | X | X | X |
| I.6 | | | |
| 5 to 70% by weight of | X | | |
| I.7 | | | |
| 5 to 70% by weight of | | X | |
| I.7 | | | |
| 5 to 70% by weight of | | | X |
| I.7 | | | |
| 5 to 70% by weight of | X | X | |
| I.7 | | | |
| 5 to 70% by weight of | X | | X |
| I.7 | | | |
| 5 to 70% by weight of | | X | X |
| I.7 | | | |
| 5 to 70% by weight of | X | X | X |
| I.7 | | | |

5 to 70 percent by weight of a mixture of compounds I.1 to I.7 and 30 to 95 percent by weight of compound II1.1

or,

to 70 percent by weight of a mixture of compounds I.1 to I.7 and 30 to 95 percent by weight of compound II.2

or,

5 to 70 percent by weight of a mixture of compounds I.1 to I.7 and 30 to 95 percent by weight of compound II.3

or,

5 to 70 percent by weight of a mixture selected from compound I.1, I.2, I.3, I.4, I.5, I.6 and I.7 and 30 to 95 percent by weight of a mixture selected from compound II.1, II.2 and II.3.

In the plasticizer composition disclosed, the weight ratio of the at least one compound of the general formula (I) and the at least one compound of the general formula (II) can be in the range from 1:19 to 7:3. It may be preferable that the weight ratio is in the range from 1:11.5 to 7:3. It may be further preferable that the weight ratio is in the range from 1:9 to 7:3. For instance, the weight ratio of at least one compound of the general formula (I) and at least one compound of the general formula (II) can be in the range from 1:15, 1:5, 1:1, or 2:1.

A plasticizer composition, in addition to at least one compound of the general formula (I) and (II), can comprise at least one plasticizer which is different to the compounds of the general formula (I) and (II).

A plasticizer which is different to the compounds of the general formula (I) or (II) can be, for example, a dialkyl cyclohexane-1,2-dicarboxylate having 4 to 6 carbon atoms and/or 13 carbon atoms in the alkyl chains, a dialkyl cyclohexane-1,3-dicarboxylate, a dialkyl cyclohexane-1,4-dicarboxylate, a dialkyl terephthalate, a dialkyl phthalate, a dialkyl malate, a dialkyl acetylmalate, an alkyl benzoate, a dibenzoic acid ester, a saturated alkyl monocarboxylate, an unsaturated monocarboxylate, a saturated dicarboxylic acid diester, an unsaturated dicarboxylic acid diester, an aromatic sulfonic acid ester, an alkylsulfonic acid ester, a glycerol ester, an isosorbide ester, a phosphoric acid ester, a citric acid triester, an acylated citric acid triester, an alkylpyrrolidone derivative, a dialkyl 2,5-furandicarboxylate, a dialkyl 2,5-tetrahydrofurandicarboxylate, a polyester of aliphatic and/or aromatic polycarboxylic acids having at least dihydric alcohols, an epoxidized vegetable oil or an epoxidized fatty acid monoalkyl ester.

A dialkyl cyclohexane-1,2-dicarboxylate, which is different to the compound of the general formula (II), generally comprises 4 to 6 and/or 13 carbon atoms in the alkyl chains. The alkyl chains of the dialkyl cyclohexane-1,2-dicarboxylate different to the compound of the general formula (II) may each independently comprise a different number of carbon atoms.

A dialkyl cyclohexane-1,3-dicarboxylate may comprise 4 to 13 carbon atoms in the alkyl chains. The alkyl chains of the dialkyl cyclohexane-1,3-dicarboxylate may each independently comprise a different number of carbon atoms.

A dialkyl cyclohexane-1,4-dicarboxylate may comprise 4 to 13 carbon atoms in the alkyl chains. The alkyl chains of the dialkyl cyclohexane-1,4-dicarboxylate may each independently comprise a different number of carbon atoms. A dialkyl cyclohexane-1,4-dicarboxylate may be, for example, di(2-ethylhexyl) cyclohexane-1,4-dicarboxylate.

A dialkyl terephthalate may comprise 4 to 12 carbon atoms in the alkyl chains. The alkyl chains may each independently comprise a different number of carbon atoms. A terephthalic ester can be, for example, di-n-butyl terephthalate, diisobutyl terephthalate or di(2-ethylhexyl) terephthalate.

A dialkyl phthalate may comprise 9 to 13 carbon atoms in the alkyl chains. The alkyl chains may each independently comprise a different number of carbon atoms. A dialkyl phthalate can be, for example, diisononyl phthalate.

A dialkyl malate or a dialkyl acetylmalate may comprise 4 to 13 carbon atoms in the alkyl chains. The alkyl chains of the dialkyl malate or the dialkyl acetylmalate may each independently comprise a different number of carbon atoms.

An alkyl benzoate may comprise 7 to 13 carbon atoms in the alkyl chain. An alkyl benzoate can be, for example, isononyl benzoate, isodecyl benzoate, or 2-propylheptyl benzoate.

A dibenzoic acid ester can be, for example, diethylene glycol dibenzoate, dipropylene glycol dibenzoate, tripropylene glycol dibenzoate or dibutylene glycol dibenzoate.

A saturated monocarboxylic ester can be, for example, an ester of acetic acid, an ester of butyric acid, an ester of valeric acid, or an ester of lactic acid. A saturated monocarboxylic ester can also be an ester of a monocarboxylic acid with a polyvalent alcohol. For instance, pentaerythritol can be fully esterified with valeric acid.

An unsaturated monocarboxylic ester can be, for example, an ester of acrylic acid.

An unsaturated dicarboxylic diester can be, for example, an ester of maleic acid.

An alkylsulfonic ester may comprise 8 to 22 carbon atoms in the alkyl chain. An alkylsulphonic ester may be, for example, a phenyl or cresyl ester of pentadecylsulfonic acid.

An isosorbide ester is generally an isosorbide diester which has been esterified with C₈- to C₁₃-carboxylic acids. An isosorbide diester may comprise different or identical C₈- to C₁₃-alkyl chains.

A phosphoric ester can be tri-2-ethylhexyl phosphate, trioctyl phosphate, triphenyl phosphate, isodecyl diphenyl phosphate, or bis-2(2-ethylhexyl) phenyl phosphate, 2-ethylhexyl diphenyl phosphate.

In a citric acid triester, the OH group may be present in free or carboxylated form, for example acetylated form. The alkyl chains of the citric acid triester or the acetylated citric acid triester each independently comprise 4 to 8 carbon atoms.

An alkylpyrrolidone derivative may comprise 4 to 18 carbon atoms in the alkyl chain.

A dialkyl 2,5-furandicarboxylate may comprise 5 to 13 carbon atoms in the alkyl chains. The alkyl chains of the dialkyl 2,5-furandicarboxylate may each independently comprise a different number of carbon atoms.

A dialkyl 2,5-tetrahydrofurandicarboxylate may comprise 5 to 13 carbon atoms in the alkyl chains. The alkyl chains of the dialkyl 2,5-tetrahydrofurandicarboxylate may each Independently comprise a different number of carbon atoms.

A polyester having aromatic or aliphatic polycarboxylic acids can be a polyester based on adipic acid with polyhydric alcohols, such as dialkylene glycol adipates having 2 to 6 carbon atoms in the alkylene unit. Examples can be polyester adipates, polyglycol adipates and polyester phthalates.

If in the plasticizer composition disclosed at least one plasticizer is present which is different from that of the compound of the general formula (I) and (II), the content thereof in the plasticizer composition disclosed is up to 50 percent by weight, based on the total amount of all plasticizers present in the plasticizer composition. It may be preferable that the content in the plasticizer composition disclosed is up to 40 percent by weight. It may be further preferable that the content in the plasticizer composition disclosed is up to 25 percent by weight. In general, however, it may be preferable that no plasticizer different to the compounds of the general formula (I) and (II) is present in the plasticizer composition disclosed.

A subject matter of the disclosure is likewise a molding composition comprising the disclosed plasticizer composition and at least one polymer.

The molding composition disclosed may accordingly also comprise a mixture of polymers.

In the molding composition comprising the disclosed plasticizer composition, at least one thermoplastic is usually present. The molding composition disclosed may accordingly also comprise a mixture of thermoplastics.

A molding composition may comprise, for example

| | Trialkyl trimellitate and diakyl | | |
|---|---|---|---|
| | cyclohexane-1,2-dicarboxylate | | |
| Thermoplastic | I.3 and II.1 | I.3 and II.2 | I.3 and II.3 |
| TP 30 | X | | |
| TP 30 | | X | |
| TP 30 | | | X |
| TP 30 | X | X | |
| TP 30 | X | | X |
| TP 30 | | X | X |
| TP 30 | X | X | X |
| TP 29 | X | | |
| TP 29 | | X | |
| TP 29 | | | X |
| TP 29 | X | X | |
| TP 29 | X | | X |
| TP 29 | | X | X |
| TP 29 | X | X | X |
| Homo- and/or copolymers of | X | | |
| vinyl acetate | | | |
| Homo- and/or copolymers of | | X | |
| vinyl acetate | | | |
| Homo- and/or copolymers of | | | X |
| vinyl acetate | | | |
| Homo- and/or copolymers of | X | X | |
| vinyl acetate | | | |
| Homo- and/or copolymers of | X | | X |
| vinyl acetate | | | |
| Homo- and/or copolymers of | | X | X |
| vinyl acetate | | | |
| Homo- and/or copolymers of | X | X | X |
| vinyl acetate | | | |
| Homo- and/or copolymers of | X | | |
| styrene | | | |
| Homo- and/or copolymers of | | X | |
| styrene | | | |
| Homo- and/or copolymers of | | | X |
| styrene | | | |
| Homo- and/or copolymers of | X | X | |
| styrene | | | |
| Homo- and/or copolymers of | X | | X |
| styrene | | | |
| Homo- and/or copolymers of | | X | X |
| styrene | | | |
| Homo- and/or copolymers of | X | X | X |
| styrene | | | |
| TP14 | X | | |
| TP14 | | X | |
| TP14 | | | X |
| TP14 | X | X | |
| TP14 | X | | X |
| TP14 | | X | X |
| TP14 | X | X | X |
| TP 6 | X | | |
| TP 6 | | X | |
| TP 6 | | | X |
| TP 6 | X | X | |
| TP 6 | X | | X |
| TP 6 | | X | X |
| TP 6 | X | X | X |
| TP 7 | X | | |
| TP 7 | | X | |
| TP 7 | | | X |
| TP 7 | X | X | |
| TP 7 | X | | X |
| TP 7 | | X | X |
| TP 7 | X | X | X |
| | Trialkyl trimellitate derivative and | | |
| | dialkyl cyclohexane-1,2-dicarboxylate | | |
| Thermoplastic | 1.4 and II.1 | 1.4 and II.2 | 1.4 and II.3 |
| TP 30 | X | | |
| TP 30 | | X | |
| TP 30 | | | X |
| TP 30 | X | X | |
| TP 30 | X | | X |
| TP 30 | | X | X |
| TP 30 | X | X | X |
| TP 29 | X | | |
| TP 29 | | X | |
| TP 29 | | | X |
| TP 29 | X | X | |
| TP 29 | X | | X |
| TP 29 | | X | X |
| TP 29 | X | X | X |
| Homo- and/or copolymers of | X | | |
| vinyl acetate | | | |
| Homo- and/or copolymers of | | X | |
| vinyl acetate | | | |
| Homo- and/or copolymers of | | | X |
| vinyl acetate | | | |
| Homo- and/or copolymers of | X | X | |
| vinyl acetate | | | |
| Homo- and/or copolymers of | X | | X |
| vinyl acetate | | | |
| Homo- and/or copolymers of | | X | X |
| vinyl acetate | | | |
| Homo- and/or copolymers of | X | X | X |
| vinyl acetate | | | |
| Homo- and/or copolymers of | X | | |
| styrene | | | |
| Homo- and/or copolymers of | | X | |
| styrene | | | |
| Homo- and/or copolymers of | | | X |
| styrene | | | |
| Homo- and/or copolymers of | X | X | |
| styrene | | | |
| Homo- and/or copolymers of | X | | X |
| styrene | | | |
| Homo- and/or copolymers of | | X | X |
| styrene | | | |
| Homo- and/or copolymers of | X | X | X |
| styrene | | | |
| TP14 | X | | |
| TP14 | | X | |
| TP14 | | | X |
| TP14 | X | X | |
| TP14 | X | | X |
| TP14 | | X | X |
| TP14 | X | X | X |
| TP 6 | X | | |
| TP 6 | | X | |
| TP 6 | | | X |
| TP 6 | X | X | |
| TP 6 | X | | X |
| TP 6 | | X | X |
| TP 6 | X | X | X |
| TP 7 | X | | |
| TP 7 | | X | |
| TP 7 | | | X |
| TP 7 | X | X | |
| TP 7 | X | | X |
| TP 7 | | X | X |
| TP 7 | X | X | X |

Depending on the polymer which is present in the molding composition disclosed, it may be that, in order to achieve the desired thermoplastic properties, various amounts of the disclosed plasticizer composition have to be present in the molding composition disclosed. Adjustment of the desired thermoplastic properties of the disclosed molding composition is generally a matter of routine to a person skilled in the art.

If no polyvinyl chloride is present in the molding composition disclosed, the amount of plasticizer composition disclosed in the molding composition disclosed is generally 0.5 to 300 phr. It may be preferable that the amount of disclosed plasticizer composition in the molding composition disclosed is 1.0 to 130 phr. It may be further preferable that the amount of disclosed plasticizer composition in the molding composition is 2.0 to 100 phr. The amount of plasticizer composition disclosed which is present in the molding composition disclosed can be, for example, 5, 10, 15, 20, 25, 30, 35, 40, 45, 50, 55, 60, 65, 70, 75, 80, 85, 90 or 95 phr.

If polyvinyl chloride is present in the molding composition, the amount of plasticizer composition disclosed in the molding composition disclosed is generally 5 to 300 phr. It may be preferable that the amount of disclosed plasticizer composition in the molding composition disclosed is 15 to 200 phr. It may be further preferable that the amount of disclosed plasticizer composition in the molding composition disclosed is 30 to 150 phr. The amount of plasticizer composition disclosed which is present in the molding composition disclosed can be, for example, 35, 40, 45, 50, 55, 60, 65, 70, 75, 80, 85, 90, 95, 100, 105, 110, 115, 120, 125, 130, 135, 140 or 145 phr.

As a rule, the molding composition disclosed comprises 20 to 90 percent by weight polyvinyl chloride. It may be preferable that the molding composition comprises 40 to 90 percent by weight polyvinyl chloride and more preferably 45 to 85 percent by weight. For example, the molding composition disclosed may comprise 50, 55, 60, 65, 70, 75 or 80 percent by weight polyvinyl chloride.

The molding composition disclosed comprising at least one thermoplastic and the disclosed plasticizer composition may also comprise further additives. Likewise, the plastisol disclosed comprising at least one thermoplastic and the disclosed plasticizer composition may also comprise further additives. Additives can be, for example, stabilizers, lubricants, fillers, colorants, flame retardants, light stabilizers, blowing agents, polymeric processing agents, impact modifiers, optical brighteners, antistatic agents, biostabilizers or a mixture thereof.

The additives described hereinafter do not limit the disclosed molding composition or the disclosed plastisol, but rather serve only for elucidating the disclosed molding composition or disclosed plastisol.

Stabilizers can be the customary polyvinyl chloride stabilizers in solid and liquid form such as Ca/Zn, Ba/Zn, Pb, Sn stabilizers, carbonates such as hydrotalcite, acid-binding sheet silicates or mixtures thereof.

The molding composition disclosed or the plastisol disclosed may comprise a content of stabilizers of 0.05 to 7 percent by weight, based on the total weight of the molding composition or plastisol. It may be preferable that the content of stabilizers is 0.1 to 5 percent by weight and more preferably 0.5 to 3 percent by weight.

As a rule, lubricants serve to reduce the adhesion between the disclosed molding composition or the disclosed plastisol and the surfaces, and should lower, for example, the friction forces on mixing, plastification or shaping.

Lubricants used in the disclosed molding composition or in the disclosed plastisol can be all lubricants commonly used in plastics processing. Common lubricants in plastics processing are, for example, hydrocarbons such as oils, paraffins, PE waxes or mixtures thereof, fatty alcohols having 6 to 20 carbon atoms, ketones, carboxylic acids such as fatty acids, montanic acids or mixtures thereof, oxidized PE waxes, metal salts of carboxylic adds, carboxamides, carboxylic esters which result from esterification of alcohols such as ethanol, fatty alcohols, glycerol, ethanediol or pentaerythritol with long-chain carboxylic acids.

The molding composition disclosed or the plastisol disclosed may comprise a content of lubricants of 0.01 to 10 percent by weight, based on the total weight of the molding composition or plastisol. It may be preferable that the content of lubricants is 0.05 to 5 percent by weight and more preferably 0.2 to 2 percent by weight.

Fillers are generally used to positively influence the compressive strength, tensile strength and/or flexural strength, the hardness and/or heat distortion temperature, of the disclosed molding composition or disclosed plastisol.

The fillers that may be present in the disclosed molding composition or disclosed plastisol can be, for example, carbon black and/or Inorganic fillers. Inorganic fillers may be natural calcium carbonates such as chalk, limestone, marble, synthetic calcium carbonates, dolomite, silicates, silica, sand, diatomaceous earth, aluminum silicates such as kaolin, mica, feldspar or any desired mixture of two or more of the fillers mentioned above.

The molding composition disclosed or the plastisol disclosed may comprise a content of fillers of 0.01 to 80 percent by weight, based on the total weight of the molding composition or plastisol. It may be preferable that the content of fillers is 0.01 to 60 percent by weight and more preferably 1 to 40 percent by weight. For Instance, the molding composition disclosed or the plastisol disclosed may comprise a content of fillers of 2, 5, 8, 10, 12, 15, 18, 20, 22, 25, 27, 30, 33, 36 or 39 percent by weight.

Colorants can serve to adjust the disclosed molding composition or the disclosed plastisol to different possible applications. Colorants can be, for example, pigments or dyes.

The pigments that may be present in the disclosed molding composition or disclosed plastisol can be, for example, inorganic and/or organic pigments. Inorganic pigments can be cobalt pigments such as CoO/Al₂O₃ and/or chromium pigments such as Cr₂O₃. Organic pigments can be monoazo pigments, condensed azo pigments, azomethine pigments, anthraquinone pigments, quinacridones, phthalocyanine pigments and/or dioxazine pigments.

The molding composition disclosed or the plastisol disclosed may comprise a content of colorants of 0.01 to 10 percent by weight, based on the total weight of the molding composition or plastisol. It may be preferable that the content of colorants is 0.05 to 5 percent by weight and more preferably 0.1 to 3 percent by weight.

Flame retardants can serve to reduce the flammability of the disclosed molding composition or the disclosed plastisol and smoke formation in the case of combustion.

Flame retardants which can be present in the disclosed molding composition or disclosed plastisol can be, for example, antimony trioxide, chloroparaffin, phosphate esters, aluminum hydroxide and/or boron compounds.

The molding composition disclosed or the plastisol disclosed may comprise a content of flame retardants of 0.01 to 10 percent by weight, based on the total weight of the molding composition or plastisol. It may be preferable that the content of flame retardants is 0.2 to 5 percent by weight and more preferably 0.5 to 2 percent by weight.

Light stabilizers such as UV absorbers can serve to protect the molding composition disclosed or the plastisol disclosed from damage due to the influence of light.

Light stabilizers can be, for example, hydroxybenzophenones, hydroxyphenylbenzotriazoles, cyanoacrylates, “hindered amine light stabilizers” such as derivatives of 2,2,6,6-tetramethylpiperldine or mixtures of the compounds mentioned above.

The molding composition disclosed or the plastisol disclosed may comprise a content of light stabilizers of 0.01 to 7 percent by weight, based on the total weight of the molding composition or plastisol. It may be preferable that the content of light stabilizers Is 0.02 to 4 percent by weight and more preferably 0.5 to 3 percent by weight.

The plasticizer composition disclosed and at least one elastomer can also be present in the molding composition disclosed.

Accordingly, the plasticizer composition disclosed and a mixture of elastomers may also be present in the molding composition disclosed.

An elastomer can be, for example, a rubber. A rubber can be a natural rubber or a rubber produced by a synthetic route. Rubber produced by a synthetic route can be, for example, polyisoprene rubber, styrene-butadiene rubber, butadiene rubber, nitrile-butadiene rubber, chloroprene rubber.

As a rule, the molding composition disclosed comprises at least natural rubber and/or at least one synthetic rubber in which the rubber or rubber mixture present can be vulcanized with sulfur.

The molding composition disclosed usually comprises at least one elastomer at a proportion of 20 to 95 percent by weight, based on the total weight of the molding composition. It may be preferable that the molding composition disclosed comprises at least one elastomer at a proportion of 45 to 90 percent by weight. It may be further preferable that the molding composition disclosed comprises at least one elastomer at a proportion of 50 to 85 percent by weight. The molding composition disclosed may comprise, for example, 55, 60, 65, 70, 75 or 80 percent by weight of at least one elastomer.

If at least one elastomer is present in the molding composition disclosed, specifically at least natural rubber or at least one synthetic rubber, the amount of plasticizer composition disclosed in the molding composition is generally 1 to 60 phr. It may be preferable that the amount of disclosed plasticizer composition in the molding composition is 2 to 40 phr and further 3 to 30 phr.

The amount of plasticizer composition disclosed which is present in the molding composition can be, for example, 5, 10, 15, 20 or 25 phr.

A mixture of at least one thermoplastic and at least one elastomer can also be present in the molding composition disclosed. For instance, a mixture of polyvinyl chloride and at least one elastomer can be present in the molding composition disclosed.

If polyvinyl chloride and at least one elastomer is present in the molding composition, the content of elastomer is generally 1 to 50 percent by weight, based on the total weight of the molding composition. It may be preferable that the content of elastomer is 3 to 40 percent by weight, based on the total weight of the molding composition. It may be further preferable that the content of elastomer is 5 to 30 percent by weight, based on the total weight of the molding composition. The molding composition disclosed may comprise, for example, 10, 15, 20 or 25 percent by weight of elastomer.

Depending on the composition of the mixture of polyvinyl chloride and at least one elastomer in the molding composition, the required amount of disclosed plasticizer composition in the molding composition for achieving the desired properties can vary widely. The appropriate amount of the disclosed plasticizer composition to use in order to achieve the desired properties is a matter of routine to a person skilled in the art.

As a rule, the amount of disclosed plasticizer composition in the molding composition comprising polyvinyl chloride and at least elastomer is 0.5 to 300 phr. It may be preferable that the amount of disclosed plasticizer composition in the molding composition comprising polyvinyl chloride and at least one elastomer is 1 to 150 phr and further 2 to 120 phr. The amount of plasticizer composition disclosed which is present in the molding composition can be, for example, 5, 10, 15, 20, 25, 30, 35, 40, 45, 50, 55, 60, 65, 70, 75, 80, 85, 90, 95, 100, 105, 110 or 115 phr.

A molding composition comprising the disclosed plasticizer composition and at least one elastomer can also comprise further additives. Additives can be, for example, carbon black, silicon dioxide, phenolic resins, vulcanizing or crosslinking agents, vulcanizing or crosslinking accelerators, activators, various oils, age resistors or a mixture of the additives specified.

Further additives can be substances which a person skilled in the art would admix, owing to his specialist knowledge in tires or other rubber compostions, in order to achieve a certain effect.

A subject matter of the disclosure is likewise a plastisol comprising the disclosed plasticizer composition and at least one polymer.

The plastisol disclosed may accordingly also comprise a mixture of polymers.

In general, a plastisol is a suspension of finely-powdered polymer in liquid plasticizer, in which the dissolution rate of the polymer in the liquid plasticizer is very low at room temperature. On heating the suspension of finely-powdered polymer in liquid plasticizer, a substantially homogeneous phase between polymer and plasticizer is formed. In this case, the individual isolated plastic components swell and combine to give a three-dimensional highly viscous gel. This procedure is generally referred to as gelation and takes place from a certain minimum temperature.

This minimum temperature is generally referred to as the gelling or dissolution temperature. The heat required for this can be introduced by means of the parameters of temperature and/or residence time. The more rapidly the gelling proceeds (indication here is the dissolution temperature, i.e. the lower this is, the more rapidly the plastisol gels), a lower temperature (at the same residence time) or residence time (at the same temperature) can be selected.

As a rule, at least one thermoplastic is present in a plastisol.

A plastisol may comprise, for example

| | Trialkyl trimellitate and dialkyl | | |
|---|---|---|---|
| | cyclohexane-1,2-dicarboxylate | | |
| Thermoplastic | I.3 and II.1 | I.3 and II.2 | I.3 and II.3 |
| TR 30 | X | | |
| TP 30 | | X | |
| TP 30 | | | X |
| TP 30 | X | X | |
| TP 30 | X | | X |
| TP 30 | | X | X |
| TP 30 | X | X | X |
| TP 29 | X | | |
| TP 29 | | X | |
| TP 29 | | | X |
| TP 29 | X | X | |
| TP 29 | X | | X |
| TP 29 | | X | X |
| TP 29 | X | X | X |
| Homo- and/or copolymers of | X | | |
| vinyl acetate | | | |
| Homo- and/or copolymers of | | X | |
| vinyl acetate | | | |
| Homo- and/or copolymers of | | | X |
| vinyl acetate | | | |
| Homo- and/or copolymers of | X | X | |
| vinyl acetate | | | |
| Homo- and/or copolymers of | X | | X |
| vinyl acetate | | | |
| Homo- and/or copolymers of | | X | X |
| vinyl acetate | | | |
| Homo- and/or copolymers of | X | X | X |
| vinyl acetate | | | |
| Homo- and/or copolymers of | X | | |
| styrene | | | |
| Homo- and/or copolymers of | | X | |
| styrene | | | |
| Homo- and/or copolymers of | | | X |
| styrene | | | |
| Homo- and/or copolymers of | X | X | |
| styrene | | | |
| Homo- and/or copolymers of | X | | X |
| styrene | | | |
| Homo- and/or copolymers of | | X | X |
| styrene | | | |
| Homo- and/or copolymers of | X | X | X |
| styrene | | | |
| TP14 | X | | |
| TP14 | | X | |
| TP14 | | | X |
| TP14 | X | X | |
| TP14 | X | | X |
| TP14 | | X | X |
| TP14 | X | X | X |
| TP 6 | X | | |
| TP 6 | | X | |
| TP 6 | | | X |
| TP 6 | X | X | |
| TP 6 | X | | X |
| TP 6 | | X | X |
| TP 6 | X | X | X |
| TP 7 | X | | |
| TP 7 | | X | |
| TP 7 | | | X |
| TP 7 | X | X | |
| TP 7 | X | | X |
| TP 7 | | X | X |
| TP 7 | X | X | X |
| | Trialkyl trimellitate derivative and | | |
| | dialkyl cyclohexane-1,2-dicarboxylate | | |
| Thermoplastic | I.4 and II.1 | I.4 and II.2 | I.4 and II.3 |
| TP 30 | X | | |
| TP 30 | | X | |
| TP 30 | | | X |
| TP 30 | X | X | |
| TP 30 | X | | X |
| TP 30 | | X | X |
| TP 30 | X | X | X |
| TP 29 | X | | |
| TP 29 | | X | |
| TP 29 | | | X |
| TP 29 | X | X | |
| TP 29 | X | | X |
| TP 29 | | X | X |
| TP 29 | X | X | X |
| Homo- and/or copolymers of | X | | |
| vinyl acetate | | | |
| Homo- and/or copolymers of | | X | |
| vinyl acetate | | | |
| Homo- and/or copolymers of | | | X |
| vinyl acetate | | | |
| Homo- and/or copolymers of | X | X | |
| vinyl acetate | | | |
| Homo- and/or copolymers of | X | | X |
| vinyl acetate | | | |
| Homo- and/or copolymers of | | X | X |
| vinyl acetate | | | |
| Homo- and/or copolymers of | X | X | X |
| vinyl acetate | | | |
| Homo- and/or copolymers of | X | | |
| styrene | | | |
| Homo- and/or copolymers of | | X | |
| styrene | | | |
| Homo- and/or copolymers of | | | X |
| styrene | | | |
| Homo- and/or copolymers of | X | X | |
| styrene | | | |
| Homo- and/or copolymers of | X | | X |
| styrene | | | |
| Homo- and/or copolymers of | | X | X |
| styrene | | | |
| Homo- and/or copolymers of | X | X | X |
| styrene | | | |
| TP14 | X | | |
| TP14 | | X | |
| TP14 | | | X |
| TP14 | X | X | |
| TP14 | X | | X |
| TP14 | | X | X |
| TP14 | X | X | X |
| TP 6 | X | | |
| TP 6 | | X | |
| TP 6 | | | X |
| TP 6 | X | X | |
| TP 6 | X | | X |
| TP 6 | | X | X |
| TP 6 | X | X | X |
| TP 7 | X | | |
| TP 7 | | X | |
| TP 7 | | | X |
| TP 7 | X | X | |
| TP 7 | X | | X |
| TP 7 | | X | X |
| TP 7 | X | X | X |

Depending on the polymer which is present in the plastisol, it may be that, in order to achieve the desired plastisol properties, various amounts of the disclosed plasticizer composition have to be present in the plastisol. Adjustment of the desired plastisol properties is generally a matter of routine to a person skilled in the art.

If the plastisol comprises polyvinyl chloride, the fraction of the disclosed plasticizer composition in the plastisol is typically 30 to 400 phr, preferably 50 to 200 phr.

The content of plasticizers of the general formula (I) in a plastisol comprising polyvinyl chloride is usually at least 10 phr, can be preferably at least 15 phr and can be especially at least 20 phr.

The plasticizer composition disclosed can be used as plasticizer for a polymer or a mixture of polymers.

The plasticizer composition disclosed can be used as plasticizer for a thermoplastic or a mixture of thermoplastics.

The plasticizer composition disclosed can also be used as plasticizer for an elastomer or a mixture of elastomers.

An elastomer can be a natural rubber or a rubber produced by a synthetic route. Rubber produced by a synthetic route can be, for example, polyisoprene rubber, styrene-butadiene rubber, butadiene rubber, nitrile-butadiene rubber, chloroprene rubber or any desired mixture thereof.

The plasticizer composition disclosed can also be used as plasticizer for a mixture comprising at least one elastomer and at least one thermoplastic.

The plasticizer composition disclosed is usually used as plasticizer for polyvinyl chloride, a polyvinyl chloride copolymer or a mixture of polymers comprising polyvinyl chloride.

The plasticizer composition disclosed can be used as plasticizer in a plastisol.

The plasticizer composition disclosed is usually used as plasticizer in a plastisol comprising polyvinyl chloride.

The molding composition disclosed is used in the production of moldings or films.

Moldings may be, for example, containers, apparatuses or foamed devices.

Containers may be, for example, housings for electrical appliances such as kitchen appliances or computer housings, tubes, hoses such as water or irrigation hoses, industrial rubber hoses, chemical hoses, sheathings for wire or cables, sheathings for tools, bicycle, roller or wheelbarrow handles, metal coatings or packing containers.

Apparatuses may be, for example, tools, furniture such as stools, shelves, tables, records, profiles such as floor profiles for exteriors or profiles for conveyor belts or components for vehicle construction such as bodywork constituents, underbody protection or vibration dampers, or erasers.

Foamed devices may be, for example, cushions, mattresses, foams or insulation materials.

Films may be, for example, tarpaulins such as vehicle tarpaulins, roof tarpaulins, geomembranes, stadium roofs or tent tarpaulins, seals, composite films such as films for composite safety glass, self-adhesive films, laminating films, shrink films, floor coverings for exteriors, adhesive strip films, coatings, films for swimming pools, films for ornamental ponds or artificial leather.

The molding composition disclosed can be used for producing moldings or films which come into direct contact with humans or foodstuffs.

Moldings or films which come into direct contact with humans or foodstuffs may be, for example, medicinal products, hygiene products, food packaging, products for interior space, products for babies and children, childcare articles, sport or leisure products, clothing, fibers or fabric.

Medicinal products which can be produced using the molding composition disclosed may be, for example, tubes for enteral nutrition or hemodialysis, breathing tubes, draining tubes, infusion tubes, infusion bags, blood bags, catheters, tracheal tubes, disposable syringes, gloves or breathing masks.

Food packaging which can be produced using the molding composition disclosed may be, for example, freshness retention films, sleeves for food products, drinking water tubes, containers for storing or freezing foodstuffs, gaskets, sealing caps, bottle caps or plastic wine corks.

Products for interior space which can be produced using the molding composition disclosed may be, for example, floor coverings, which can be constructed homogeneously or composed of several layers consisting of at least one foamed layer, such as ground coverings, mud flap mats, sports floors, luxury vinyl tiles (LVT), artificial leather, wallcoverings, foamed or non-foamed wallpaper in buildings, cladding or console covers in vehicles.

Products for babies and children, which can be produced using the molding composition disclosed may be, for example, toys, such as dolls, game pieces or modelling days, inflatable toys such as balls or rings, slipper socks, swimming aids, stroller coverings, diaper-changing pads, hot-water bottles, teething rings or flasks.

Sport or leisure products, which can be produced using the molding composition disclosed may be, for example, gymnastic balls, exercise mats, seat cushions, massage balls or rollers, shoes, shoe soles, balls, air mattresses or drinking bottles.

Clothing, which can be produced using the molding composition disclosed may be, for example, latex clothing, protective clothing, rain jackets or rubber boots.

Plastisols are typically made into the form of the finished product at ambient temperature by various processes such as coating processes, casting processes such as the slush molding process or rotomolding process, dip-coating processes, printing processes such as the screen-printing process, spray processes and the like. Subsequently, gelation is effected by heating whereupon, after cooling, a homogeneous more or less flexible product is obtained.

The plastisol disclosed may be used for producing films, wallcoverings, seamless hollow bodies, gloves, heterogeneous floors or for application in the textile sector such as, for example, textile coatings.

Films may be, for example, vehicle tarpaulins, roof tarpaulins, coverings in general such as boat coverings, stroller coverings or stadium roofs, tent tarpaulins, geomembranes, tablecloths, coatings, films for swimming pools, artificial leather or films for ornamental ponds.

Gloves may be, for example, gardening gloves, medicinal gloves, gloves for handling chemicals, protective gloves or disposable gloves.

Furthermore, the plastisol disclosed can be used, for example, for producing seals such as gaskets, cladding or console covers in vehicles, dolls, game pieces or modelling clays, inflatable toys such as balls or rings, slipper socks, swimming aids, diaper-changing pads, gymnastic balls, exercise mats, seat cushions, vibrators, massage balls or rollers, latex clothing, protective clothing, rain jackets or rubber boots.

The plastisol disclosed usually comprises polyvinyl chloride.

Also a subject matter of the disclosure is the use of the disclosed plasticizer composition as calendering aid or rheology aid. Also subject matter of the present disclosure is the use of the disclosed plasticizer composition in surface-active compositions such as flow promoters and film-forming auxiliaries, defoamers, antifoamers, wetting agents, coalescents or emulsifiers. The plasticizer composition disclosed can also be used in lubricants such as lubricant oils, lubricant greases or lubricant pastes. The plasticizer composition disclosed can also be used as quenching agent for chemical reactions, phlegmatizers, in pharmaceutical products, in adhesives, in sealants, in printing inks, in impact modifiers or means of adjustment.

Subject matter of the disclosure are moldings or films comprising the plasticizer composition disclosed. Reference is made to the statements made on the use of molding compositions for producing moldings or films to provide moldings or films. The examples listed here for moldings or films are used for configuring the concepts of moldings or films in this section.

Preparing compound of the general formula (I)

Compounds of the general formula (I) can be prepared, for example, by esterifying corresponding tricarboxylic acids, 1,2,4-benzenetricarboxylic acid for example, with the appropriate aliphatic alcohols. Methods and specific process steps are either known to a person skilled in the art or are accessible to him/her by his/her general technical knowledge.

These include the reaction of at least one alcohol component, selected from the alcohols R^{1a}—OH, R^{1b}—OH and R^{1c}—OH, with an appropriate tricarboxylic acid, 1,2,4-benzenetricarboxylic acid for example, or a suitable derivative thereof. Suitable derivatives are, for example, acid halides and acid anhydrides. An acid halide may be an acid chloride for example. The reaction may be carried out in the presence of an esterification catalyst.

The esterification catalysts used can be customary catalysts for this purpose, e.g. mineral acids such as sulfuric acid or phosphoric acid; organic sulfonic acids such as methanesulfonic acid or p-toluenesulfonic acid; amphoteric catalysts, especially titanium, tin(IV) or zirconium compounds such as, e.g. tetrabutoxytitanium, or tin(IV) oxide. The water which forms in the reaction can be removed by customary measures, by distillation for example. For Instance, WO 02/038531 describes a method for preparing esters in which a) a mixture consisting essentially of the acid component or an anhydride thereof and the alcohol component are heated to boiling in a reaction zone in the presence of an esterification catalyst, b) the vapors comprising the alcohol and water are separated by rectification into an alcohol-rich fraction and a water-rich fraction, c) the alcohol-rich fraction is recycled to the reaction zone and the water-rich fraction is discharged from the process. The catalysts mentioned above are used as esterification catalysts. The esterification catalyst is used in an effective amount, which is typically in the range from 0.05 to 10% by weight, preferably 0.1 to 5% by weight, based on the sum total of acid component (or anhydride) and alcohol component. Further detailed descriptions for carrying out esterification processes are found, for example in U.S. Pat. No. 6,310,235 B1, U.S. Pat. No. 5,324,853 A, DE-A 2612355 (Derwent Abstract No. DW 77-72638 Y) or DE-A 1945359 (Derwent Abstract No. DW 73-27151 U). Reference is fully made to the documents specified.

In general, the esterification of the appropriate tricarboxylic acids, 1,2,4-benzenetricarboxylic acid for example, may be carried out in the presence of the aforementioned alcohol components R^{1a}—OH, R^{1b}—OH and/or R^{1c}—OH by means of an organic acid or mineral acid, especially concentrated sulfuric acid. It may be advantageous in this case that the alcohol component is used in at least a two-fold stoichiometric amount, based on 1,2,4-benzenetricarboxylic acid or a derivative thereof.

The esterification can be effected at ambient pressure or reduced or elevated pressure. It may be preferable that the esterification is carried out at ambient pressure or reduced pressure.

The esterification may be carried out in the absence of an added solvent or in the presence of a solvent.

If the esterification is carried out in the presence of a solvent, it is preferably a solvent inert under the reaction conditions. Inert solvent is generally understood to mean a solvent which, under the given reaction conditions, does not enter into any reactions with the reactants, reagents or solvents involved in the reaction or the products which form. Preferably, the inert solvent can form an azeotrope with water. These include, for example, aliphatic hydrocarbons, halogenated aliphatic hydrocarbons, aromatic and substituted aromatic hydrocarbons or ethers. It may be preferable that the solvent is selected from pentane, hexane, heptane, ligroin, petroleum ether, cyclohexane, dichloromethane, trichloromethane, tetrachloromethane, benzene, toluene, xylene, chlorobenzene, dichlorobenzenes, dibutyl ether, THF, dioxane and mixtures thereof.

The esterification is typically carried out in a temperature range from 50 to 250° C.

If the esterification catalyst is selected from organic acids or mineral acids, the esterification is typically carried out in a temperature range from 50 to 160° C.

If the esterification catalyst is selected from amphoteric catalysts, the esterification is typically carried out in a temperature range from 100 to 250° C.

The esterification can be effected in the absence or presence of an Inert gas. An inert gas is generally understood to mean a gas which, under the given reaction conditions, does not enter into any reactions with the reactants, reagents or solvents involved in the reaction or the products which form. It may be preferable that the esterification is effected without adding an inert gas.

For example, the alcohol and the acid are combined without inert gas in a molar ratio of 2:1 in a stirred flask together with the esterification catalyst aluminum trimethylsulfonate in a molar ratio of 400:1, based on the acid. The reaction mixture is heated to boiling point, preferably from 100 to 140° C. The water which forms in the reaction is distilled off as an azeotrope together with the alcohol and is subsequently separated off. The alcohol is fed back again to the reaction mixture.

The 1,2,4-benzenetricarboxylic acid and aliphatic alcohols used to prepare the compounds of the general formula (I) can either be purchased commercially or can be prepared by synthetic routes known from the literature.

Transesterification

The compounds of the general formula (I) can also be prepared by transesterification. Transesterification methods and specific process steps are either known to a person skilled in the art or are accessible to him/her by his/her general technical knowledge. In general, compounds of the general formula (I) in which R^{1a}, R^{1b} and R^{1c} are each independently C₁- to C₂-alkyl serve as reactants. This includes for example the reaction of appropriate trialkyl tricarboxylates, for example trimethyl trimellitate, triethyl trimellitate, dimethyl ethyl trimellitate or methyl diethyl trimellitate or mixtures thereof, with at least one alcohol component selected from the alcohols R^{1a}—OH, R^{1b}—OH and R^{1c}—OH, where R^{1a}, R^{1b} and R^{1c} are C₃- to C₅-alkyl, in the presence of a suitable transesterification catalyst.

Suitable transesterification catalysts are, for example, the customary catalysts commonly used for transesterification reactions, which are also usually used in esterification reactions. These include, e.g. mineral acids such as sulfuric acid or phosphoric acid; organic sulfonic acids such as methanesulfonic acid or p-toluenesulfonic acid; or specific metal catalysts from the group comprising tin(IV) catalysts, for example dialkyltin dicarboxylates such as dibutyltin diacetate, trialkyltin alkoxides, monoalkytin compounds such as monobutyltin dioxide, tin salts such as tin acetate or tin oxides; from the group comprising titanium catalysts, monomeric or polymeric titanates or titanium chelates such as tetraethyl orthotitanate, tetrapropyl orthotitanate, tetrabutyl orthotitanate, triethanolamine titanate; from the group comprising zirconium catalysts, zirconates or zirconium chelates such as tetrapropyl zirconate, tetrabutyl zirconate, triethanolamine zirconate; and lithium catalysts such as lithium salts, lithium alkoxides; or aluminum(II), chromium(II), iron(III), cobalt(II), nickel(II) and zinc(II) acetylacetonate.

The amount of transesterification catalyst used can in general be 0.001 to 10% by weight. It may be preferable that the amount is 0.05 to 5% by weight. The reaction mixture is generally heated to the boiling point of the reaction mixture such that the reaction temperature, depending on the reactants, is in a temperature range from 20 to 200° C.

The transesterification can be effected at ambient pressure or reduced or elevated pressure. It may be preferable that the transesterification is carried out at a pressure from 0.001 to 200 bar and more preferably at a pressure from 0.01 to 5 bar.

The lower-boiling alcohol cleaved off in the transesterification, for the purpose of shifting the equilibrium of the transesterification reaction, can be continuously distilled off. The distillation column required for this purpose is generally in direct contact with the transesterification reactor.

For example, the distillation column can be Installed directly on the transesterification reactor. In the case of the use of two or more transesterification reactors connected in series, each of these reactors may be equipped with a distillation column or the alcohol mixture evaporated off can be fed via one or more collecting lines to a distillation column, preferably from the last tank of the transesterification reactor cascade. The higher-boiling alcohol recovered in this distillation is preferably fed back again to the transesterification.

In the case of the use of an amphoteric catalyst, the removal thereof is generally achieved by hydrolysis and subsequent removal of the metal oxide formed, for example by filtration. It may be preferable that, after reaction is complete, the catalyst is hydrolyzed by washing with water and the precipitated metal oxide is filtered off. The filtrate can be subjected to further processing for isolating and/or purifying the product. It may be preferable that the product is separated by distillation.

The transesterification of the tri(C₁-C₂)-alkyl esters of appropriate tricarboxylic acids, 1,2,4-benzenetricarboxylic acid for example, with at least one alcohol component selected from the alcohols R^{1a}—OH, R^{1b}—OH and R^{1c}—OH where R^{1a}, R^{1b} and R^{1c} are C₃- to C₅-alkyl, can be carried out preferably in the presence of at least one titanium(IV) alkoxide. Preferred titanium(IV) alkoxides are tetrapropoxy titanium, tetrabutoxy titanium or mixtures thereof. It may be preferable that the alcohol component is used in at least a two-fold stoichiometric amount, based on the tri(C₁-C₂-alkyl) ester used.

The transesterification may be carried out in the absence or in the presence of an added solvent. It may be preferable that the transesterification is carried out in the presence of an inert solvent. Suitable solvents are those mentioned above for esterification. These especially include toluene and THF.

The temperature in the transesterification is generally in a range from 20 to 200° C.

The transesterification can be effected in the absence or presence of an inert gas. An Inert gas is generally understood to mean a gas which, under the given reaction conditions, does not enter into any reactions with the reactants, reagents or solvents Involved in the reaction or the products which form. It may be preferable that the transesterification is carried out without addition of an inert gas.

Preparation of compounds of the general formula (II)

The compounds of the general formula (II) can either be purchased commercially or can be prepared by methods which are either known to those skilled in the art or are accessible to them by their general technical knowledge.

As a rule, 1,2-cyclohexanedicarboxylates are obtained by ring hydrogenation of the corresponding phthalic esters. The ring hydrogenation can be effected, for example, by processes described in WO 99/32427. WO 2011/082991 A2 for example also describes a particularly suitable ring hydrogenation method.

In addition, 1,2-cyclohexanedicarboxylic esters can be obtained, for example by esterification of 1,2-cyclohexanedicarboxylic acid or suitable derivatives thereof with the corresponding alcohols. Methods and specific process steps are either known to those skilled in the art or are accessible to them by their general technical knowledge.

Common to methods for preparing the compounds of the general formula (II) is that, starting from phthalic add, 1,2-cyclohexanedicarboxylic acid or suitable derivatives thereof, an esterification or transesterification is carried out in which the corresponding C₇-C₁₂-alkanols are used as reactants. These alcohols are generally not pure substances but are isomeric mixtures, the composition and degree of purity of which depends on the respective methods with which these have been prepared.

C₇-C₁₂-alkanols, which are used for preparing the compounds (II) present in the plasticizer composition, can be straight-chain or branched or consist of mixtures of straight-chain and branched C₇-C₁₂-alkanols. These include for example n-heptanol, isoheptanol, n-octanol, isooctanol, 2-ethylhexanol, n-nonanol, isononanol, isodecanol, 2-propylheptanol, n-undecanol, isoundecanol, n-dodecanol or isododecanol. It may be preferable that 2-ethylhexanol, isononanol and 2-propylheptanol are used as alkanols and that isononanol is further used.

Heptanol

The heptanols used for preparing the compounds of the general formula (II) can be straight-chain or branched or consist of mixtures of straight-chain and branched heptanols. It may be preferable that mixtures of branched heptanols, also referred to as isoheptanol, are used, which are prepared by the rhodium- or preferably cobalt-catalyzed hydroformylation of dimer propene, obtainable by the Dimersol® process for example, and subsequent hydrogenation of the resulting isoheptanals to give an isoheptanol mixture. According to its preparation, the isoheptanol mixture thus obtained consists of two or more isomers. Largely straight-chain heptanols can be obtained by the rhodium- or preferably cobalt-catalyzed hydroformylation of 1-hexene and subsequent hydrogenation of the resulting n-heptanal to give n-heptanol. 1-Hexene or dimer propene can be hydroformylated by methods known per se: in the hydroformylation using rhodium catalysts homogeneously dissolved in the reaction medium, both non-complexed rhodium carbonyls, which are formed, for example, from rhodium salts in situ under the conditions of the hydroformylation reaction in the hydroformylation reaction mixture by exposure to synthesis gas, and complex rhodium carbonyl compounds, especially complexes with organic phosphines such as triphenylphosphine, or organophosphites, preferably chelating biphosphites described for example in U.S. Pat. No. 5,288,918, are used as catalyst. In the cobalt-catalyzed hydroformylation of these olefins, cobalt carbonyl compounds generally homogeneously soluble in the reaction mixture are used, which are formed from cobalt salts in situ under the conditions of the hydroformylation reaction by exposure to synthesis gas. If the cobalt-catalyzed hydroformylation is carried out in the presence of trialkylphosphines or triarylphosphines, the desired heptanols are formed directly as hydroformylation product such that further hydrogenation of the aldehyde function is no longer required.

Suitable for the cobalt-catalyzed hydroformylation of 1-hexene or hexene isomeric mixtures are, for example, the industrially established methods elucidated in Falbe, New Syntheses with Carbon Monoxide, Springer, Berlin, 1980 on pages 162-168, such as the Ruhrchemle process, the BASF process, the Kuhlmann process or the Shell process. Whereas the Ruhrchemie, BASF and the Kuhlmann processes operate with non-ligand-modified cobalt carbonyl compounds as catalyst and hexanal mixtures are thus obtained, the Shell process (DE-A 1593368) uses phosphine- or phosphite-ligand-modified cobalt carbonyl compounds as catalysts which, owing to their additional high hydrogenation activity, lead directly to hexanol mixtures. Advantageous configurations for carrying out the hydroformylation using non-ligand-modified cobalt carbonyl complexes are described in detail, for example, in DE-A 2139630, DE-A 2244373, DE-A 2404855 and WO 01014297.

The industrially established rhodium low-pressure hydroformylation process using triphenylphosphine ligand-modified rhodium carbonyl compounds can be applied to the rhodium-catalyzed hydroformylation of 1-hexene or the hexene isomeric mixtures, as is the subject matter, for example, of U.S. Pat. No. 4,148,830. It may be advantageous that non-ligand-modified rhodium carbonyl compounds serve as catalyst for the rhodium-catalyzed hydroformylation of long-chain olefins, such as the hexene isomeric mixtures obtained by the processes mentioned above, in which, in contrast to the low pressure process, a higher pressure of 80 to 400 bar is set. The procedure for such a rhodium high-pressure hydroformylation process is described, for example, in EP-A 695734, EP-B 880494 and EP-B 1047655.

The isoheptanal mixtures obtained by hydroformylation of the hexene isomeric mixtures can be catalytically hydrogenated, for example in a conventional manner, to give isoheptanol mixtures. It may be preferable that heterogeneous catalysts are used for this purpose comprising, as catalytically active components, metals and/or metal oxides of the VI to VIII and the I transition group of the Periodic Table of Elements, especially chromium, molybdenum, manganese, rhenium, iron, cobalt, nickel and/or copper, optionally precipitated onto a support material such as Al₂O₃, SiO₂ and/or TiO₂. Such catalysts are described, e.g. in DE-A 3228881, DE-A 2628987 and DE-A 2445303. It may be further preferable that the hydrogenation of the isoheptanals is carried out with an excess of hydrogen of 1.5 to 20% over the stoichiometric amount of hydrogen required for the hydrogenation of the isoheptanals, at temperatures from 50 to 200° C. and at a hydrogen pressure from 25 to 350 bar and, to avoid secondary reactions, a low amount of water is added to the hydrogenation feed in accordance with DE-A 2628987, for example in the form of an aqueous solution of an alkali metal hydroxide or carbonate according to the teaching of WO 01087809.

Octanol

2-Ethylhexanol, which for many years was the plasticizer alcohol produced in the largest quantities, can be obtained, for example, by the aldol condensation of n-butyraldehyde to give 2-ethylhexenal and subsequent hydrogenation thereof to give 2-ethylhexanol (see Ullmann's Encyclopedia of Industrial Chemistry; 5th Edition, Vol. A 10, pp. 137-140, VCH Verlagsgesel-schaft GmbH, Weinheim 1987).

Largely straight-chain octanols can be obtained, for example, by the rhodium- or preferably cobalt-catalyzed hydroformylation of I-heptene and subsequent hydrogenation of the resulting n-octanal to give n-octanol. The 1-heptene required for this can be obtained, for example, from Fischer-Tropsch synthesis of hydrocarbons.

The alcohol isooctanol, in contrast to 2-ethylhexanol or n-octanol, by reason of its manner of production, is generally not a single chemical compound, but rather is an isomeric mixture of various branched C₈-alcohols, for example composed of 2,3-dimethyl-1-hexanol, 3,5-dimethyl-1-hexanol, 4,5-dimethyl-1-hexanol, 3-methyl-1-heptanol and 5-methyl-1-heptanol which, depending on the production conditions and processes applied, may be present in the isooctanol in various ratios. Isooctanol is typically prepared by the co-dimerization of propene with butenes such as n-butenes, and subsequent hydroformylation of the mixture of heptene isomers obtained. The octanal isomer mixture obtained in the hydroformylation can subsequently be hydrogenated to isooctanol in a conventional manner.

The co-dimerization of propene with butenes to give isomeric heptenes can be effected, for example, with the aid of the homogeneously catalyzed Dimersol® process (for example Chauvin et al; Chem. Ind.; May 1974, pp. 375-378), in which a soluble nickel phosphine complex serves as catalyst in the presence of an ethylaluminum chlorine compound, for example ethylaluminum dichloride. The phosphine ligands that can be used for the nickel complex catalyst are e.g. tributylphosphine, triisopropylphosphine, tricyclohexylphosphine and/or tribenzylphosphine. The reaction takes place generally at temperatures from 0 to 80° C., wherein it may be advantageous to set a pressure in which the olefins are present in dissolved form in the liquid reaction mixture (for example Cornils; Hermann: Applied Homogeneous Catalysis with Organometallic Compounds; 2nd edition; Vol. 1; pp. 254-259, Wiley-VCH, Weinheim 2002).

As an alternative to the Dimersol® process operated with nickel catalysts homogeneously dissolved in the reaction medium, the co-dimerization of propene with butenes can also be carried out with heterogeneous NiO catalysts precipitated on a support, in which similar heptene isomer distributions are obtained to the homogeneously catalyzed process. Such catalysts are used, for example, in the so-called Octol® process (Hydrocarbon Processing, February 1986, pp. 31-33); a particularly suitable specific heterogeneous nickel catalyst for olefin dimerization or co-dimerization is disclosed, for example, in WO 9514647.

Instead of catalysts based on nickel, heterogeneous Brønsted acid catalysts for co-dimerizing propene with butenes can also be used, in which generally more highly branched heptenes are obtained than in the nickel-catalyzed processes. Examples of catalysts suitable for this purpose are solid phosphoric acid catalysts, for example kieselguhr or diatomaceous earth impregnated with phosphoric acid, such as are used, for example, in the PolyGas® process for olefin dimerization or oligomerization (for example Chitnis at al; Hydrocarbon Engineering 10, No. 6-June 2005). For the co-dimerization of propene and butenes to give heptenes, very well-suited Brønsted acid catalysts are mostly zeolites, which is served for example by the further developed EMOGAS® process based on the PolyGas® process.

1-heptene and the heptene Isomeric mixtures are converted to n-octanal or octanal isomeric mixtures by the known methods elucidated in connection with the preparation of n-heptanal and heptanal isomeric mixtures, by means of rhodium- or cobalt-catalyzed hydroformylation, preferably cobalt-catalyzed hydroformylation. These are subsequently hydrogenated to the corresponding octanols, for example by means of the catalysts mentioned above in connection with the preparation of n-heptanol and isoheptanol.

Nonanol

Essentially straight-chain nonanols can be obtained, for example, by the rhodium- or preferably cobalt-catalyzed hydroformylation of 1-octene and subsequent hydrogenation of the resulting n-nonanal. The starting olefin 1-octene can be obtained, for example, via ethylene oligomerization by means of a nickel complex catalyst homogeneously soluble in the reaction medium—1,4-butanediol—with e.g. diphenylphosphinoacetic acid or 2-diphenylphosphinobenzoic acid as ligands. This process is also known by the name Shell Higher Olefins Process or SHOP process (for example Weisermel, Arpe: Industrielle Organische Chemie; 5th edition; p. 96; Wiley-VCH, Weinheim 1998).

In the case of isononanol, which is used for the synthesis of the diisononyl ester of the general formula (II) present in the disclosed plasticizer composition, is not a homogeneous chemical compound but rather a mixture of various branched isomeric C₉-alcohols which, depending on the type of preparation thereof, particularly also the starting materials used, can have varying degrees of branching. In general, the isononanols are prepared by dimerizing butenes to isooctene mixtures, subsequent hydroformylation of the isooctene mixtures and hydrogenation of the resulting isononanal mixtures to give isononanol mixtures, as elucidated for example in Ulmann's Encyclopedia of Industrial Chemistry, 5th edition, Vol. A1, pp. 291-292, VCH Ver-lagsgesellschaft GmbH, Weinheim 1995.

As starting materials for preparing the isononanols, both isobutene, cis- and trans-2-butene and 1-butene or mixtures of these butane isomers can be used. In the case of dimerization of pure isobutene, catalyzed predominantly by liquid, for example sulfuric acid or phosphoric acid, or solid,

for example phosphoric acid or zeolites applied to kieselguhr, SiO₂ or Al₂O₃ as support material or Brønsted acids, the highly branched 2,4,4-trimethylpentene, also referred to as diisobutylene, is predominantly obtained, which affords highly branched isononanols after hydroformylation and hydrogenation of the aldehyde.

Isononanols having a low degree of branching may be preferable. Such lightly branched Isononanol mixtures are obtained from the linear butenes 1-butane, cis- and/or trans-2-butene, which may optionally still comprise low amounts of isobutene, for example via the route described above of butane dimerization, hydroformylation of the isooctene and hydrogenation of the resulting isononanal mixtures. It may be preferable that raffinate II is used as raw material. Raffinate II can generally be obtained from the C₄ cut of a cracker, a steamcracker for example which, by elimination of allenes, acetylenes and dienes, especially 1,3-butadiene, by partial hydrogenation thereof to give linear butenes or removal thereof by extractive distillation, for example by means of N-methylpyrrolidone, and subsequent Brønsted acid-catalyzed removal of the isobutene present therein by reaction thereof with methanol or isobutanol by industrial scale established methods, results in formation of the fuel additive methyl tert-butyl ether (MTBE) or of isobutyl tert-butyl ether which serves to provide pure isobutene.

Raffinate II, besides 1-butene and cis- and trans-2-butene, may still comprise n-butane and isobutane and residual amounts of up to 5% by weight isobutene.

The dimerization of linear butenes or of the butane mixture present in raffinate II can be carried out, for example, by the common industrial scale processes practiced, such as has been elucidated above in connection with the generation of isoheptena mixtures, for example by means of heterogeneous Brønsted acid catalysts, as are used in the PolyGas® or EMOGAS® processes for example, by means of the Dimersol® process using nickel complex catalysts dissolved homogeneously in the reaction medium or by means of heterogeneous nickel(II) oxide-containing catalysts by the Octol® process or the method according to WO 9514647 for example. The isooctane mixtures obtained in this case are converted to isononanal mixtures by the known methods elucidated in connection with the preparation of heptanal isomeric mixtures, by means of rhodium- or cobalt-catalyzed hydroformylation, preferably cobalt-catalyzed hydroformylation. These are subsequently hydrogenated to the suitable isononanol mixtures, for example by means of one of the catalysts mentioned in connection with the preparation of isoheptanol.

The isononanol isomeric mixtures thus produced can be characterized by their iso index, which can be calculated from the degree of branching of the individual isomeric isononanol components in the isononanol mixture multiplied by their percentage fraction in the isononanol mixture. For instance, n-nonanol with the value 0, methyloctanols (one branching point) with the value 1 and dimethylheptanols (two branching points) with the value 2 contribute to the iso index of an isononanol mixture. The greater the linearity, the lower the iso index of the isononanol mixture in question. Accordingly, the iso index of an isononanol mixture can be determined by gas chromatographic separation of the isononanol mixture into its individual isomers and accompanying quantification of their percentage fractional amount in the isononanol mixture, determined by standard methods of gas chromatography analysis. For the purpose of increasing the volatility and improving the gas chromatographic separation of the isomeric nonanols, these are advantageously trimethylsilylated prior to gas chromatographic analysis by standard methods, for example by reaction with N-methyl-N-trimethylsilyltrifluoroacetamide. In order to achieve as good a separation as possible of the individual components in the gas chromatographic analysis, capillary columns with polydimethylsiloxane as stationary phase are typically used. Such capillary columns are commercially available, and it only needs a few routine experiments by those skilled in the art to select an optimal maker for this separation task from the multifarious offers on the market.

The diisononyl esters of the general formula (II) used in the plasticizer composition disclosed are generally esterified with isononanols having an Iso index of 0.8 to 2, preferably of 1.0 to 1.8 and particularly preferably of 1.1 to 1.5, which can be prepared by the methods mentioned above.

In the following, only exemplary possible compositions of isononanol mixtures are specified, as can be used for preparing compounds of the general formula (II) according to the disclosure, wherein it is to be noted that the fractions of the specifically listed isomers in the isononanol mixture may vary, depending on the composition of the starting material, raffinate II for example, the composition of butenes of which may vary as a result of the production process and fluctuations in the production conditions applied, for example the age of the catalysts used and temperature and pressure conditions to be adjusted thereto.

For example, an isononanol mixture, which has been produced by cobalt-catalyzed hydroformylation and subsequent hydrogenation of an isooctene mixture produced, using raffinate II as raw material, by means of the catalyst and method according to WO 9514647, may have the following composition:
1.73 to 3.73% by weight, preferably 1.93 to 3.53% by weight, particularly preferably 2.23 to 3.23% by weight 3-ethyl-6-methylhexanol;
0.38 to 1.38% by weight, preferably 0.48 to 1.28% by weight, particularly preferably 0.58 to 1.18% by weight 2,6-dimethylheptanol;
2.78 to 4.78% by weight, preferably 2.98 to 4.58% by weight, particularly preferably 3.28 to 4.28% by weight 3,5-dimethylheptanol;
6.30 to 16.30% by weight, preferably 7.30 to 15.30% by weight, particularly preferably 8.30 to 14.30% by weight 3,6-dimethylheptanol;
5.74 to 11.74% by weight, preferably 6.24 to 11.24% by weight, particularly preferably 6.74 to 10.74% by weight 4,6-dimethylheptanol;
1.64 to 3.64% by weight, preferably 1.84 to 3.44% by weight, particularly preferably 2.14 to 3.14% by weight 3,4,5-trimethylhexanol;
1.47 to 5.47% by weight, preferably 1.97 to 4.97% by weight, particularly preferably 2.47 to 4.47% by weight 3,4,5-trimethylhexanol, 3-methyl-4-ethylhexanol and 3-ethyl-4-methylhexanol;
4.00 to 10.00% by weight, preferably 4.50 to 9.50% by weight, particularly preferably 5.00 to 9.00% by weight 3,4-dimethylheptanol;
0.99 to 2.99% by weight, preferably 1.19 to 2.79% by weight, particularly preferably 1.49 to 2.49% by weight 4-ethyl-5-methylhexanol and 3-ethylheptanol;
2.45 to 8.45% by weight, preferably 2.95 to 7.95% by weight, particularly preferably 3.45 to 7.45% by weight 4,5-dimethylheptanol and 3-methyloctanal;
1.21 to 5.21% by weight, preferably 1.71 to 4.71% by weight, particularly preferably 2.21 to 4.21% by weight 4,5-dimethylheptanol;
1.55 to 5.55% by weight, preferably 2.05 to 5.05% by weight, particularly preferably 2.55 to 4.55% by weight 5,6-dimethylheptanol;
1.63 to 3.63% by weight, preferably 1.83 to 3.43% by weight, particularly preferably 2.13 to 3.13% by weight 4-methyloctanol;
0.98 to 2.98% by weight, preferably 1.18 to 2.78% by weight, particularly preferably 1.48 to 2.48% by weight 5-methyloctanol;
0.70 to 2.70% by weight, preferably 0.90 to 2.50% by weight, particularly preferably 1.20 to 2.20% by weight 3,6,6-trimethylhexanol;
1.96 to 3.96% by weight, preferably 2.16 to 3.76% by weight, particularly preferably 2.46 to 3.46% by weight 7-methyloctanol;
1.24 to 3.24% by weight, preferably 1.44 to 3.04% by weight, particularly preferably 1.74 to 2.74% by weight 6-methyloctanol;
0.1 to 3% by weight, preferably 0.2 to 2% by weight, particularly preferably 0.3 to 1% by weight n-nonanol;
to 35% by weight, preferably 28 to 33% by weight, particularly preferably 29 to 32% by weight of other alcohols having 9 and 10 carbon atoms; with the proviso that the total sum of the components specified is 100% by weight.

In accordance with the above statements, an isononanol mixture which has been produced by cobalt-catalyzed hydroformylation and subsequent hydrogenation of an isooctene mixture generated using an ethylene-containing butene mixture as raw material by means of the PolyGas® or EMOGAS® process, can vary in the range of the following compositions, depending on the raw material composition and fluctuations in the reaction conditions used:
6.0 to 16.0% by weight, preferably 7.0 to 15.0% by weight, particularly preferably 8.0 to 14.0% by weight n-nonanol;
12.8 to 28.8% by weight, preferably 14.8 to 26.8% by weight, particularly preferably 15.8 to 25.8% by weight 6-methyloctanol;
12.5 to 28.8% by weight, preferably 14.5 to 26.5% by weight, particularly preferably 15.5 to 25.5% by weight 4-methyloctanol;
3.3 to 7.3% by weight, preferably 3.8 to 6.8% by weight, particularly preferably 4.3 to 6.3% by weight 2-methyloctanol;
5.7 to 11.7% by weight, preferably 6.3 to 11.3% by weight, particularly preferably 6.7 to 10.7% by weight 3-ethylheptanol;
1.9 to 3.9% by weight, preferably 2.1 to 3.7% by weight, particularly preferably 2.4 to 3.4% by weight 2-ethylheptanol;
1.7 to 3.7% by weight, preferably 1.9 to 3.5% by weight, particularly preferably 2.2 to 3.2% by weight 2-propylhexanol;
3.2 to 9.2% by weight, preferably 3.7 to 8.7% by weight, particularly preferably 4.2 to 8.2% by weight 3,5-dimethylheptanol;
6.0 to 16.0% by weight, preferably 7.0 to 15.0% by weight, particularly preferably 8.0 to 14.0% by weight 2,5-dimethylheptanol;
1-0.8 to 3.8% by weight, preferably 2.0 to 3.6% by weight, particularly preferably 2.3 to 3.3% by weight 2,3-dimethylheptanol;
0.6 to 2.6% by weight, preferably 0.8 to 2.4% by weight, particularly preferably 1.1 to 2.1% by weight 3-ethyl-4-methylhexanol;
2.0 to 4.0% by weight, preferably 2.2 to 3.8% by weight, particularly preferably 2.5 to 3.5% by weight 2-ethyl-4-methylhexanol;
0.5 to 6.5% by weight, preferably 1.5 to 6% by weight, particularly preferably 1.5 to 5.5% by weight of other alcohols having 9 carbon atoms;
with the proviso that the total sum of the components specified is 100% by weight.

Decanol

Isodecanol, which is used for the synthesis of the diisodecyl esters of the general formula (II) present in the plasticizer composition disclosed, is generally not a single chemical compound, but rather a complex mixture of differently branched isomeric decanols.

These are in general produced by nickel or Brønsted acid-catalyzed trimerization of propylene, for example by the PolyGas® or the EMOGAS® process elucidated above, subsequent hydroformylation of the isononene isomer mixture thus obtained by means of homogeneous rhodium or cobalt carbonyl catalysts, preferably by means of cobalt carbonyl catalysts, and hydrogenation of the isodecanal isomer mixture formed, for example by means of the catalysts and processes mentioned above in connection with the production of C₇-C₉-alcohols (Ullmann's Encyclopedia of Industrial Chemistry; 5th Edition, Vol. A1, p. 293, VCH Verlagagesellschaft GmbH, Weinheim 1985). The isodecanol thus produced is in general highly branched.

2-propylheptanol, which is used for the synthesis of the di(2-propylheptyl) esters of the general formula (II) present in the plasticizer composition disclosed, can be pure 2-propylheptanol or propylheptanol isomeric mixtures, such as are in general formed in the industrial production of 2-propylheptanol and commonly also referred to as 2-propylheptanol.

Pure 2-propylheptanol can be obtained, for example, by aldol condensation of n-valeraldehyde and subsequent hydrogenation of the 2-propylheptenal thus formed, for example according to U.S. Pat. No. 2,921,089. In general, commercially available 2-propylheptanol, as well as the main component 2-propylheptanol, depending on the method of production, comprises one or more of the 2-propylheptanol isomers 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol. The presence of other isomers of 2-propylheptanol in the 2-propylheptanol, for example 2-ethyl-2,4-dimethylhexanal, 2-ethyl-2-methylheptenol and/or 2-ethyl-2,5-dimethylthexanol, is possible due to the low formation rates of the aldehydic precursors of these isomers in the course of the aldol condensation and these are only present in trace amounts, if at all, in the 2-propyl-heptanol and have practically no role in the plasticizer properties of the compounds produced from such 2-propylheptanol isomeric mixtures.

As starting material for producing 2-propylheptanol, various hydrocarbon sources can be used, for example 1-butene, 2-butene, raffinate I—an alkane/alkene mixture obtained from the C₄ cut of a cracker after removal of allenes, acetylenes and dienes, which together with 1- and 2-butene still comprises considerable quantities of isobutene—or raffinate II, which is obtained from raffinate I by removal of isobutene and as olefin components, apart from 1- and 2-butenes, still comprises only small fractions of isobutene. Self-evidently, mixtures of raffinate I and raffinate II can also be used as raw material for production of 2-propylheptanol. These olefins or olefin mixtures can be hydroformylated by conventional methods normal per se with cobalt or rhodium catalysts, wherein, from 1-butane, a mixture of n- and isovaleraldehyde—the name isovaleraldehyde refers to the compound 2-methylbutanal—is formed, the n/iso ratio of which can vary within relatively wide limits depending on the catalyst used and the hydroformylation conditions. For example, in the case of the use of a homogeneous rhodium catalyst modified with triphenylphosphine (Rh/TPP), n- and isovaleraldehyde is in general formed from 1-butene in an n/so ratio from 10:1 to 20:1, whereas in the case of the use of rhodium hydroformylation catalysts modified with phosphite ligands, for example according to U.S. Pat. No. 5,288,918 or WO 05028407, or with phosphoramidite ligands, for example according to WO 0283695, almost exclusively n-valeraldehyde is formed. Whereas the Rh/TPP catalyst system only converts 2-butene very slowly in the hydroformylation, so that the major part of the 2-butene can be recovered again from the hydroformylation mixture, the hydroformylation of the 2-butene succeeds with the phosphite ligand- or phosphoramidite ligand-modified rhodium catalysts mentioned, whereby n-valeraldehyde is predominantly formed. In contrast, isobutene present in the olefinic raw material is hydroformylated, by practically all catalyst systems, albeit at different rates, to 3-methylbutanal and to pivalaldehyde to a lesser extent depending on the catalyst.

The C₅ aldehydes obtained, i.e. n-valeraldehyde optionally in the mixture with isovaleraldehyde, 3-methylbutanal and/or pivalaldehyde, depending on the starting materials and catalysts used, can if desired, prior to the aldol condensation, be completely or partly separated by distillation into the Individual components, so that here also a possibility exists of influencing and control-ling the isomer composition of the C₁₀ alcohol component of the ester mixtures according to the disclosure. Likewise, it is possible to feed the C₅ aldehyde mixture as formed in the hydroformylation to the aldol condensation, without prior separation of individual isomers. In the aldol condensation, which can be carried out by means of a basic catalyst, such as an aqueous solution of sodium or potassium hydroxide, for example by the processes described in EP-A 366089, U.S. Pat. Nos. 4,426,524 or 5,434,313, in the case of the use of n-valeraldehyde 2-propylheptenal is formed as the only condensation product, whereas in the case of the use of a mixture of isomeric C₅ aldehydes an isomer mixture of the products of the homoaldol condensation of identical aldehyde molecules and the cross aldol condensation of different valeraldehyde isomers Is formed. Self-evidently, the aldol condensation can be controlled by specific reaction of individual isomers such that a single aldol condensation isomer is predominantly or entirely formed. The relevant aldol condensation products can then be hydrogenated to the corresponding alcohols or alcohol mixtures, typically after prior separation from the reaction mixture usually by distillation and, if desired, purification by distillation, with conventional hydrogenation catalysts, for example those mentioned above for the hydrogenation of aldehydes.

As already mentioned, the compounds of the general formula (II) present in the plasticizer composition disclosed can be esterified with pure 2-propylheptanol. In general however, mixtures of 2-propylheptanol with the propylheptanol isomers mentioned, in which the content of 2-propylheptanol is at least 50% by weight, are used for the production of these esters. It may be preferable that the content of 2-propylheptanol is 60 to 98% by weight and more preferably 80 to 95% by weight and particularly preferably 85 to 95% by weight.

Suitable mixtures of 2-propylheptanol with the propylheptanol isomers comprise, for example, those composed of 60 to 98% by weight 2-propylheptanol, 1 to 15% by weight 2-propyl-4-methylhexanol and 0.01 to 20% by weight 2-propyl-5-methylhexanol and 0.01 to 24% by weight 2-isopropylheptanol, wherein the sum of the fractions of the individual constituents does not exceed 100% by weight. It may be preferable that the fractions of the individual constituents add up to 100% by weight.

Further suitable mixtures of 2-propylheptanol with the propytheptanol isomers comprise, for example, those composed of 75 to 95% by weight 2-propylheptanol, 2 to 15% by weight 2-propyl-4-methylhexanol, 1 to 20% by weight 2-propyl-5-methylhexanol, 0.1 to 4% by weight 2-isopropylheptanol, 0.1 to 2% by weight 2-isopropyl-4-methylhexanol and 0.1 to 2% by weight 2-isopropyl-5-methylhexanol, wherein the sum of the fractions of the individual constituents does not exceed 100% by weight. It may be preferable that the fractions of the individual constituents add up to 100% by weight.

It may be preferable that mixtures of 2-propylheptanol with the propylheptanol isomers comprise those composed of 85 to 95% by weight 2-propylheptanol, 5 to 12% by weight 2-propyl-4-methylhexanol and 0.1 to 2% by weight 2-propyl-5-methylhexanol and 0.01 to 1% by weight 2-isopropylheptanol, wherein the sum of the fractions of the individual constituents does not exceed 100% by weight. It may be preferable that the fractions of the individual constituents add up to 100% by weight

In the case of the use of the 2-propylheptanol isomeric mixtures mentioned instead of pure 2-propylheptanol for the production of the compounds of the general formula (II), the isomer composition of the alkyl ester groups or alkyl ether groups practically corresponds to the composition of the propylheptanol isomeric mixtures used for the esterification.

Undecanol

The undecanols which are used for the production of the compounds of the general formula (II) present in the plasticizer composition disclosed can be straight-chain or branched or be composed of mixtures of straight-chain and branched undecanols. It may be preferable that mixtures of branched undecanols, also referred to as isoundecanol, are used as alcohol component.

Essentially straight-chain undecanol can be obtained, for example, by the rhodium- or preferably cobalt-catalyzed hydroformylation of I-decene and subsequent hydrogenation of the resulting n-undecanal. The starting olefin 1-decene is produced, for example, via the SHOP process mentioned above in the production of 1-octene.

For the production of branched isoundecanol, the 1-decene obtained in the SHOP process can be subjected to a skeletal isomerization, for example by means of acidic zeolite molecular sieve, as described in WO 9823566, whereby mixtures of isomeric decenes are formed, rhodium- or preferably cobalt-catalyzed hydroformylation thereof and subsequent hydrogenation of the isoundecanal mixtures obtained results in the isoundecanols also used for the production of the disclosed compounds of the general formula (II). The hydroformylation of 1-decene or isodecene mixtures by means of rhodium or cobalt catalysis can be effected as described above in connection with the synthesis of C₇- to C₁₀-alcohols. The same applies to the hydrogenation of n-undecanal or isoundecanal mixtures to give n-undecanol or isoundecanol.

After purification of the output from the hydrogenation by distillation, the C₇- to C₁₁-alkyl alcohols or mixtures thereof thus obtained can be used, as described above, for the production of the diester compounds of the general formula (II) disclosed.

Dodecanol

Essentially straight-chain dodecanol can be obtained, for example, via the Alfol® or Epal® processes. These processes include the oxidation and hydrolysis of straight-chain trialkylaluminum compounds, which are constructed from triethylaluminum stepwise via several ethylation reactions using Ziegler-Natta catalysts. From the mixtures of largely straight-chain alkyl alcohols of different chain length resulting therefrom, the desired n-dodecanol can be obtained by distillative output of the C₁₂-alkyl alcohol fraction.

Alternatively, n-dodecanol can also be produced by hydrogenation of natural fatty acid methyl esters, for example from coconut oil.

Branched isododecanol can be obtained analogously to the known processes for co-dimerization and/or oligomerization of olefins, as described for example in WO 0063151, with subsequent hydroformylation and hydrogenation of the isoundecene mixtures, as described for example in DE-A 4339713. After purification of the output from the hydrogenation by distillation, the isododecanols or mixtures thereof thus obtained can be used, as described above, for the production of the diester compounds of the general formula (II) disclosed.

### EXAMPLES

The invention is illustrated in more detail by reference to the figures and examples described below. Here, the figures and examples should not be construed as being limiting for the invention. In the examples, the following feedstocks are used:

| | Commercially available for example | |
|---|---|---|
| Feedstocks | as | from |
| Homopolymeric emulsion PVC | Solvin ® 367 NC | Inovyn |
| | | ChlorVinyls |
| | | Limited |
| Homopolymeric emulsion PVC | Solvin ® 271 SP | Inovyn |
| | | ChlorVinyls |
| | | Limited |
| Homopolymeric emulsion PVC | Vinnolit ® P 70 | Vinnolit GmbH |
| Isononyl benzoate | Vestinol ® INB | Evonik |
| | | Performance |
| | | Materials |
| | | GmbH |
| Isodecyl benzoate | Jayflex ® MB 10 | Exxonmobil |
| | | Petroleum & |
| | | Chemical BVBA |
| Di(isononyl) 1,2-cyclohexanedi- | Hexamoll ® | BASF SE |
| carboxylate | DINCH ® | |
| (compound II.2) | | |
| Diisononyl phthalate | Palatinol ® N | BASF SE |
| Tri(2-ethylhexyl) trimellitate | Palatinol ® TOTM | BASF Corp. |
| Ba—Zn stabilizer | Reagent SLX/781 | Reagens S.p.A. |

In all examples, homopolymeric emulsion PVC was used as Solvin® 367 NC and/or Vinnolit® P 70, isononyl benzoate as Vestinol® INB, isodecyl benzoate as Jayflex® MB 10, di(isononyl) 1,2-cyclohexanedicarboxylate as Hexamoll® DINCH®, diisononyl phthalate as Palatinol® N, tri(2-ethylhexyl) trimellitate as Palatinol® TOTM and the Ba-Zn stabilizer as Reagent SLX/781.

| Product | Vestinol ® | Jayflex ® MB | Hexamoll ® | | Palatinol ® |
|---|---|---|---|---|---|
| properties | INB | 10 | DINCH ® | Palatinol ® N | TOTM |
| Density | 0.955-0.963 g/ml | 0.950-0.955 g/ml | 0.944-0.954 g/ml | 0.970-0.977 g/ml | 0.98-0.99 g/ml |
| | at 20° C., | at 20° C., | at 20° C., | at 20° C., DIN | at 20° C., |
| | DIN 51757 | ASTM D- | DIN 51757 | 51757 | DIN 51757 |
| | (01/11) | 4052-15 | (01/11) | (01/11) | (01/11) |
| Viscosity | 8.4 mPa * s at | 5-15 mPa * s | 40-66 mPa * s | 68-82 mPa * s | 293.6 mPa * s |
| | 20° C., DIN | at 20° C., | at | at | at 20° C., DIN |
| | 153015, | ASTM D- | 20° C., ASTM | 20° C., ASTM | 53015 |
| | (02/01) | 445-15 | D 7042-14 | D 7042-14 | (02/01) |
| Acid number | max. 0.07 mg | max. 0.07 mg | max. 0.07 mg | max. 0.06 mg | 0.079 mg |
| | KOH/g, DIN | KOH/g, | KOH/g, DIN | KOH/g, DIN | KOH/g, DIN |
| | EN ISO 2114 | ASTM D- | EN ISO 2114 | EN ISO 2114 | EN iso 2114 |
| | (06/02) | 1045-14 | (06/02) | (06/02) | (06/02 |
| Refractive | 1.488-1.494 | 1.489-1.491 | 1.460-1.466 | 1.484-1.488 | 1.485-1.487 |
| index n^{D}₂₀ | at 20° C., DIN | at 20° C., | at 20° C., DIN | at 20° C., DIN | at 20° C., DIN |
| | 51423/2 | ASTM D- | 51423/2 | 51423/2 | 51423/2 |
| | (02/10) | 1218 | (02/10) | (02/10) | (02/10) |

### EXAMPLES

I) Preparation of Two Compounds of the General Formula (I) According to the Disclosure:

### Example 1

### Synthesis of tri(isobutyl) 1,2,4-benzenetricarboxylate (compound I.4)

1000 g of 1,2,4-benzenetricarboxylic anhydride and 1400 g of isobutanol were Initially charged under a protective gas, for example nitrogen. A gentle protective gas stream was further passed through the complete apparatus. After 15 minutes, 1 ml of the titanium catalyst (Tyzor® TPT-20B, Dorf Ketal B.V., 4700 BN Roosendaal/NL, butoxyisopropoxytitanium, CAS No. 68955-22-6, density at 20° C. ca. 0.97 g/ml) was added. The mixture was heated to reflux with stirring. The reaction course was controlled with the aid of a water separator. After about 150 ml of water had been collected in the water separator, the acid number was determined (in accordance with DIN EN ISO 2114 06/2002). At a value of 55 mg KOH or below, a portion of the moist isobutanol was replaced with fresh dry isobutanol and the reaction was continued under reflux until the acid number had fallen below a value of 1 mg KOH. The reaction mixture was cooled to about 100° C. and a 20% aqueous sodium hydroxide solution was then added and the mixture stirred for 30 minutes. The amount of aqueous sodium hydroxide solution required was calculated by the acid number AN:

Amount of 20% NaOH (aq) in ml=5*(AN*product weight/1000)*1.4

Excess alcohol was distilled off under reduced pressure. About 50 g of Fuller's earth was added to the still warm mixture and stirred. This was filtered off together with the precipitated catalyst residues.

This gave in total 1850 g (95% yield) of a pale yellowish oily liquid with a purity according to GC of 94%.

### Example 2

### Synthesis of tri(n-butyl) 1,2,4-benzenetricarboxylate (compound I.3)

The synthesis of tri(n-butyl) 1,2,4-benzenetricarboxylate was carried out in analogy to the synthesis in example 1. An equal amount of n-butanol was used instead of isobutanol. The product was obtained as a pale yellowish oil in a yield of 1920 g (98%) and a purity of 96%.

The following table gives the properties of the synthesized compounds in comparison with tri(2-ethylhexyl) trimellitate.

| | | | 1 Tri(isobutyl) 1,2,4- | 2 Tri(n-butyl) 1,2,4- |
|---|---|---|---|---|
| | | | benzenetricarboxylate | benzenetricarboxylate |
| Product property | Unit | Method | (compound I.4) | (compound I.3) |
| Density, 20° C. | g/cm³ | DIN 51757 Ver.4 | 1.0499 | 1.0632 |
| | | 01/11 | | |
| Viscosity, 20° C. | mPa * s | DIN 51562-1 | 397 | 195 |
| | | 01/99 | | |
| Pt/Co color number | | DIN ISO 6271 | 75 | 76 |
| | | 03/05 | | |
| Refractive, index n^{D}₂₀ | | DIN 51423-2 | 1.4878 | 1.4930 |
| | | 02/10 | | |
| Acid number | mg | DIN EN ISO 2114 | 0.089 | 0.081 |
| | KOH/g | 06/02 | | |
| Water content | % by | DIN 51777, TI. 1 | 0.021 | 0.025 |
| | weight | 03/83 | | |
| GC purity | % | | 94.3 | 96.1 |
| Dissolution | ° C. | DIN 53408 | 106 | 108 |
| temperature | | 06/67 | | |
| Microscope method | | | | |

II) Performance Tests:

II.a) Determination of the dissolution temperature in accordance with DIN 53408 (June 67 and the dynamic viscosity in accordance with the DIN 51562-4 01/99):

To characterize the gelling behavior of the compounds of the general formula (I) according to the disclosure in PVC, the dissolution temperature was determined in accordance with DIN 53408 (June 67). The lower the dissolution temperature, the better the gelling behavior of the relevant substance for PVC.

In the following table, the dissolution temperatures and dynamic viscosities of compound I.3 and compound I.4 and, as comparison, the values of the gellating aid isononyl benzoate (as Vestinol® INB) and isodecyl benzoate (as Jayflex® MB 10), and also of the plasticizer di(isononyl) 1,2-cyclohexanedicarboxylate (as Hexamoll® DINCH®), diisononyl phthalate (as Palatinol® N) and tri(2-ethylhexyl) trimellitate (as Palatinol® TOTM) are listed.

| | | Dissolution | |
|---|---|---|---|
| | | temperature- | Dynamic |
| | | in accordance | viscosity |
| | | with | in accordance |
| | | DIN 53408 | with DIN |
| | | (06/67) | 51562-1 01/99 |
| Ex. No. | Substance | [° C.] | [mPa · s] |
| 2 | Compound I.3 | 108 | 195 |
| 1 | Compound I.4 | 106 | 397 |
| V1 | Isononyl benzoate | 128 | 8.4 |
| | (as Vestinol ® INB) | | |
| V2 | Isodecyl benzoate (as Jay- | 131 | 10.0 |
| | flex ® MB 10) | | |
| V3 | Diisononyl 1,2- | 151 | 52.0 |
| | cyclohexanedicarboxylate | | |
| | (as Hexamoll ®DINCH ®) | | |
| V4 | Diisononyl phthalate | 131 | 75.0 |
| | (as Palatinol ® N) | | |
| V5 | Tri(2-ethylhexyl) trimellitate | 144 | 293 |
| | (as Palatinol ® TOTM) | | |

As is apparent from the table, compound I.3 and compound I.4 exhibit a lower dissolution temperature for PVC than the gelling aid Vestinol® INB and Jayflex® MB10. The dynamic viscosity is somewhat higher.

As is also apparent from the table, compound I.3 and compound I.4, compared to the plasticizers Hexamoll®DINCH®, Palatinol® N and Palatinol® TOTM, exhibit a distinctly lower dissolution temperature for PVC. The dynamic viscosity is usually higher.

II.b) Determination of the Gelling Behavior of Plastisols with the Plasticizer Composition According to the Disclosure:

To investigate the gelling behavior of plastisols based on the plasticizer compositions according to the disclosurpe, plastisols were produced according to the following formulation comprising PVC and a mixture of the plasticizer di(isononyl) 1,2-cyclohexanedicarboxylate (as Hexamoll®DINCH®) with compound I.3 (tri-(n-butyl) 1,2,4-benzenetricarboxylate) or compound I.4 (tri(isobutyl) 1,2,4-benzenetricarboxylate) in various ratios (Hexamoll®DINCH® to compound I.3 75/25, 73/27, 70/30, or Hexamoll®DINCH® to compound I.4 73/27, 68/32 and 66/34:

| | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition according to the disclosure | 100 |
| Ba—Zn Stabilizer, Reagent SLX/781 | 2 |

Plastisols were also prepared as comparison, comprising exclusively Hexamoll®DINCH® or Palatinol® N as plasticizer, in addition to PVC, or a plastisol having 45% by weight of the plasticizer Hexamoll®DINCH® with 55% by weight of the gellating aid Vestinol® INB and a plastisol having 33% by weight of the plasticizer Hexamoll®DINCH® with 67% by weight of the gellating aid Jayflex® MB 10.

| | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition comparison | 100 |
| Ba—Zn Stabilizer, Reagent SLX/781 | 2 |

The plastisols were produced in a manner in that the two PVC types were weighed together into a PVC-free apparatus. The liquid components were weighed into a second PVC-free apparatus. With the aid of a dissolver (Jahnke & Kunkel, IKA-Werk, Type RE-166 A, 60-6000 l/min, diameter of the dissolver disk=40 mm), the PVC was stirred into the liquid component at 400 rpm. Once the mixture was homogenized, the speed of rotation was increased to 2500 l/min and the mixture homogenized for 150 s. The plastisol was transferred from the PVC-free apparatus to a suitable apparatus, a steel dish for example, and placed under vacuum with the purpose of re-moving air present in the plastisol. Then, the plastisol was again brought to ambient pressure. The start of the rheological measurements in all plastisols was 30 min after homogenization.

The viscosity measurements were carried out using a heatable oscillation and rotational rheometer MCR 302 from Anton Paar in an oscillation test.

| | |
|---|---|
| measurement system: | plate/plate d = 50 mm |
| amplitude γ: | 1% |
| frequency: | 1 Hz |
| gap width: | 1 mm |
| starting temperature: | 20° C. |
| temperature profile: | 20-200° C. |
| temperature increase: | 10° C./min |
| measurement points: | 201 |
| measurement point duration: | 0.09 min |

The measurement was effected in two ramps. The first ramp served to temperature-control the sample. At 20° C., the plastisol was lightly sheared for 2 min at γ=1%. The temperature program was started with the second ramp. During the measurement, the storage modulus and the loss modulus were recorded. From the quotient of these two parameters, the complex viscosity η* was calculated. The temperature which was reached at the viscosity maximum is considered as the gelling temperature of the plastisol.

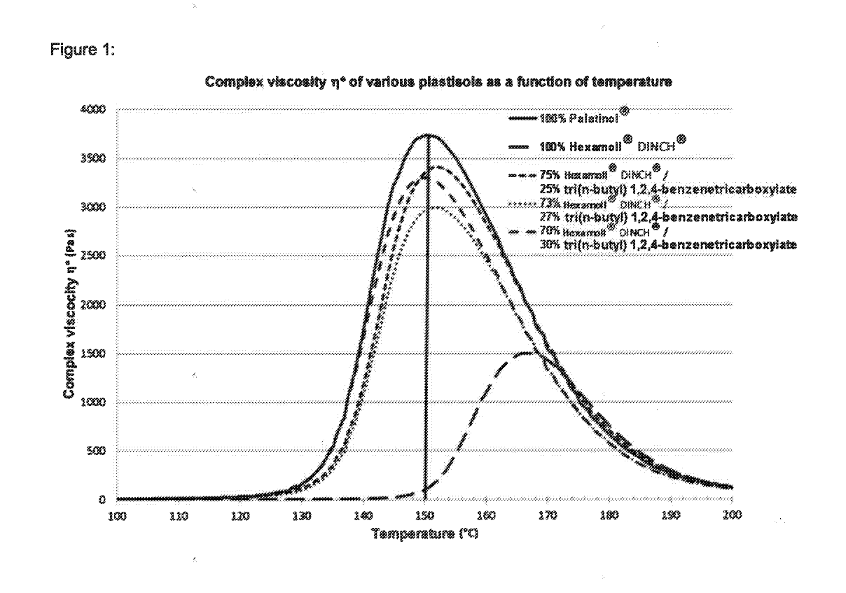

As is very readily apparent in FIG. 1, the plastisols with the plasticizer composition according to the disclosure gel at considerably lower temperatures in comparison to the plastisol exclusively comprising Hexamoll®DINCH® as plasticizer. Even at a composition of 75% by weight Hexamoll®DINCH® and 25% by weight compound I.3, a gelling temperature of 150° C. is achieved, which corresponds to the gelling temperature of the plasticizer Palatinol® N and is sufficient for many plastisol applications. By further Increasing the fraction of compound I.3 in the plasticizer compositions according to the disclosure, the gelling temperature of the plastisols can be significantly further reduced.

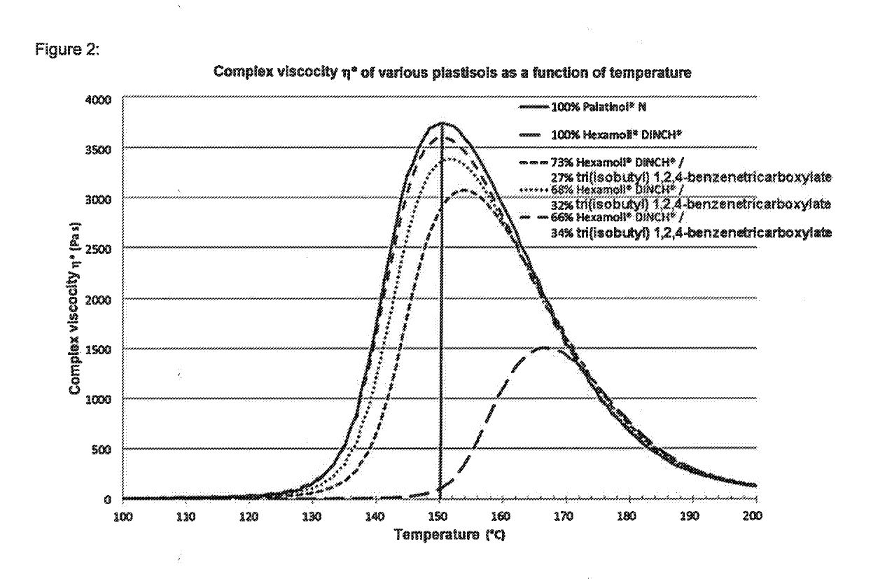

As is apparent from FIG. 2, even at a composition of 66% by weight Hexamol®DINCH® and 34% by weight compound I.4, a gelling temperature of 150° C. is achieved, which corresponds to the gelling temperature of the plasticizer Palatinol® N and is sufficient for many plastisol applications. By further increasing the fraction of compound I.4 in the plasticizer compositions according to the disclosure, the gelling temperature of the plastisols can be significantly further reduced.

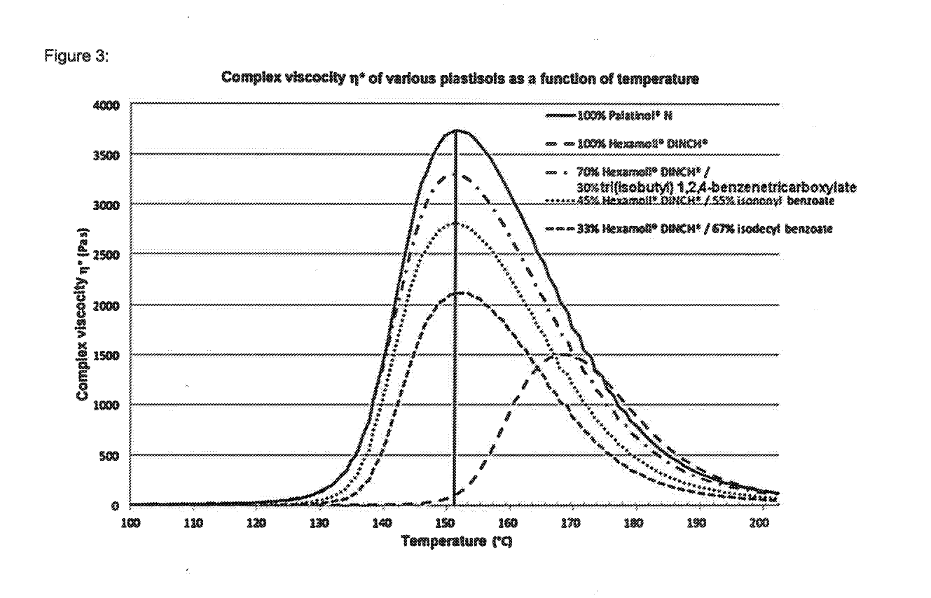

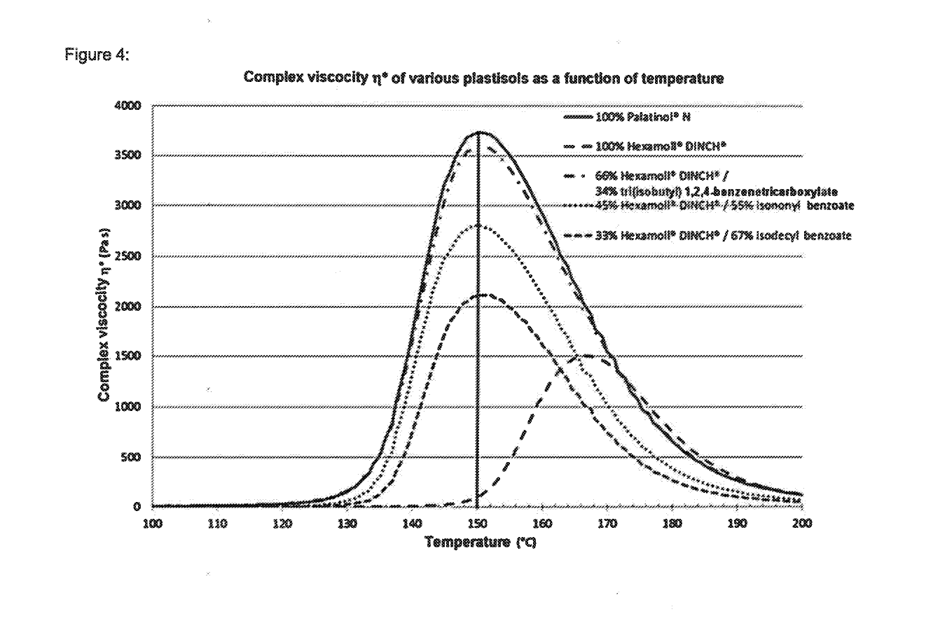

In FIG. 3 and FIG. 4, two comparative examples are included. A plastisol composed of 45% by weight of the plasticizer Hexamoll®DINCH® with 55% by weight of the gellating aid Vestinol® INB (isonyl benzoate) and a plastisol with 33% by weight of the plasticizer Hexamoll® DINCH® with 67% by weight of the gellating aid Jayflex® MB 10 (Isodecyl benzoate). In both cases, the gelling temperature of 150° C. is likewise achieved, which corresponds to the gelling temperature of isononyl phthalate.

In contrast, in the plasticizer compositions composed of the gellating aid Vestinol® INB (isononyl benzoate) and Jayflex® MB10 (isodecyl benzoate), substantially higher fractions of isononyl benzoate (55% by weight) or isodecyl benzoate (67% by weight) are required in order to achieve a gelling temperature of the plastisols of 150° C. Compound I.3 or compound I.4 accordingly possess a significantly better gelling effect than the gellating aid Vestinol® INB (isononyl benzoate) (and Jayflex® MB 10) (isodecyl benzoate) and are accordingly suitable as gellating aids.

II.c) Determination of the Process Volatility of the Plasticizer Compositions According to the Disclosure

Plastisols were prepared as described in II.b) with a plasticizer composition composed of 30% by weight compound I.3 (tri(n-butyl) 1,2,4-benzenetricarboxylate) and 70% by weight Hexamoll®DINCH® or composed of 34% by weight compound I.4 (tri(isobutyl) 1,2,4-benzenetricarboxylate) and 66% by weight Hexamoll®DINCH® and with the plasticizer compositions composed of 55% by weight Vestinol® INB (Isononyl benzoate) and 45% by weight Hexamoll®DINCH® and also 67% by weight Jayflex® MB 10 (isodecyl benzoate) and 33% by weight Hexamoll®DINCH®. The following formulation was prepared.

| | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition | 60 |
| Ba—Zn Stabilizer, Reagent SLX/781 | 2 |

As a comparison, plastisols were also produced comprising, as plasticizer, exclusively Hexamoll®DINCH® or Palatinol® N or tri(isobutyl) 1,2,4-benzenetricarboxylate (compound I.4). The following formulation was used.

| | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition comparison | 60 |
| Ba—Zn Stabilizer, Reagent SLX/781 | 2 |

Production of a Prefilm

In order to be able to determine the performance properties on the plastisols, the liquid plastisol must be converted into a processable solid film. For this purpose, the plastisol was pregelled at low temperature.

The pregelling of the plastisols was effected in a Mathis oven.

Settings on the Mathis oven:
exhaust air valve fully open
fresh air: open
circulating air: maximum position
top air/bottom air top air setting 1

Production of the Prefilm:

A new relay paper was mounted in the mounting device on the Mathis oven. The oven was preheated to 140° C.; the gelling time set to 25 s. For the gap setting, the gap between paper and doctor blade was set to 0.1 mm with the thickness template. The thickness gauge was set to 0.1 mm. The gap was then set to a value of 0.7 mm on the gauge.

The plastisol was applied to the paper and spread smooth with the doctor blade. Then, the mounting device was brought into the oven by means of the start button. After 25 s, the mounting device moves out of the oven again. The plastisol was gelled and the film that had formed could be pulled off the paper in one piece. The thickness of this film was ca. 0.5 mm.

Determination of the Process Volatility

To determine the process volatility, 3 square specimens (49×49 mm) were stamped out of each prefilm with a Shore hardness punch, weighed and then gelled for 2 minutes at 190° C. in the Mathis oven. After cooling, these specimens were reweighed and the weight loss calculated in %. For this, the specimens were always positioned exactly on the same position of the relay paper. For this purpose, at the height of the hole in the frame on which the template for the Petri dishes was secured, a line was drawn diagonally across the paper with a pen. The position of the 3 specimens was aligned with this line. They lay uniformly across the breadth on the paper centered on the line.

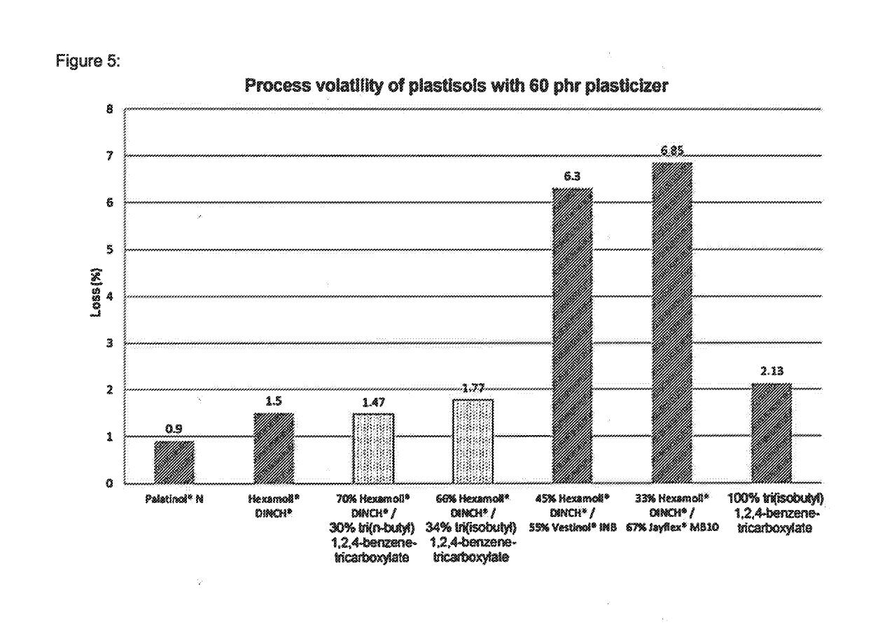

As is readily apparent from FIG. 5, the process volatility of the plasticizer composition disclosed composed of 30% by weight compound I.3 and 70% by weight Hexamoll®DINCH® or 34% by weight compound I.4 and 66% by weight Hexamoll® DINCH® is distinctly lower than the process volatility of the plasticizer compositions composed of 55% by weight Vestinol® INB and 45% by weight Hexamoll® DINCH® or 67% by weight Jaxflex® MB 10 and 33% by weight Hexamoll®DINCH®.

The process volatility of the plasticizer composition disclosed composed of 30% by weight compound 1.3 and 70% by weight Hexamoll®DINCH® or 34% by weight compound I.4 and 66% by weight Hexamoll®DINCH® is however higher than that of the pure plasticizer Palatinol® N, and distinctly lower than the process volatility of the pure gellating aid tri(isobutyl) 1,2,4-benzenetricarboxylate (compound I.4).

II.d) Determination of the Shore a Hardness of Films of Plastisols with the Plasticizer Compositions According to the Disclosure

To determine the Shore A hardness, film pieces of size 49×49 mm were stamped out of the prefilms as described in II.c) and, in analogy to the volatility test, each were gelled in triplicate at 190° C. for 2 min. In total, 27 pieces of films were thus gelled. These 27 pieces were placed on top of one another in the pressing frame and compressed at 195° C. to a 10 mm thick Shore block.

Description of the Shore Hardness Measurement:
method: DIN EN ISO 868, October 2003
title: Determination of the indentation hardness with a durometer (Shore hardness)
instrument: Hildebrand digital durometer model DD-3
specimens:
   dimensions: 49 mm×49 mm×10 mm (length×breadth×thickness)
   production: pressed from ca. 27, 0.5 mm thick gelled films,
   pressing temperature: 195° C.=5° C. above the preparation of the gelled films
storage period prior to measurement: 7 days in the climate chamber at 23° C. and 50% rel. humidity
measurement time (duration of the needle on the specimens up to read off of the value) 15 s
10 individual values were measured and the mean value calculated therefrom.

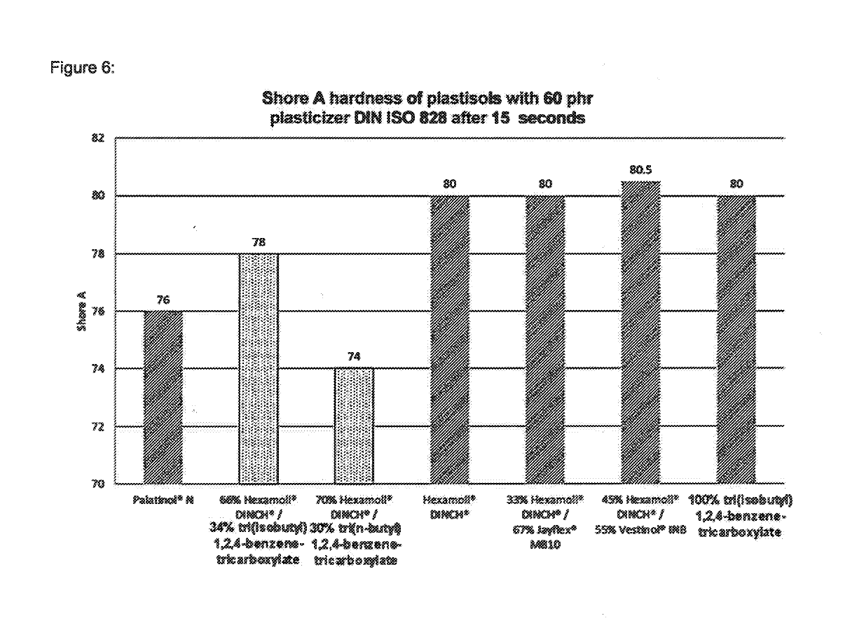

As is very readily apparent from FIG. 6, the Shore A hardness of the film of the plastisol with the disclosed plasticizer composition composed of 30% by weight compound I.3 and 70% by weight Hexamoll®DINCH® or 34% by weight compound I.4 and 66% by weight Hexamoll® DINCH® is distinctly lower than the Shore A hardness of the films of the plastisols with the plasticizer compositions composed of 55% by weight Vestinol® INB and 45% by weight Hexamoll®DINCH® and also 67% by weight Jayflex® MB 10 and 33% by weight Hexamoll® DINCH®.

The Shore A hardness of the film of the PVC plastisol with the disclosed plasticizer composition composed of 30% by weight compound I.3 and 70% by weight Hexamoll® DINCH® or 34% by weight compound I.4 and 66% by weight Hexamoll® DINCH® is moreover also distinctly lower than the Shore A hardness of the film of the PVC plastisol with the pure plasticizer Hexamoll®DINCH®. The Shore A hardness of the film of the PVC plastisol with the disclosed plasticizer composition composed of 30% by weight compound I.3 and 70% by weight Hexamoll® DINCH® is even lower than the Shore A hardness of the film of the PVC plastisol with the pure plasticizer Palatinol® N or films comprising only the gellating aid tri(Isobutyl) 1,2,4-benzenetricarboxylate (compound I.4).

II.e) Determination of the Film Volatility of Films of Plastisols with the Plasticizer Compositions According to the Disclosure

To test the film volatility, plastisols were produced as described in II.c) with the disclosed plasticizer composition composed of 30% by weight compound I.3 and 70% by weight Hexamoll® DINCH® or 34% by weight compound I.4 and 66% by weight Hexamoll®DINCH® and plastisols with the plasticizer compositions composed of 55% by weight Vestinol® INB and 45% by weight Hexamoll®DINCH® and also 67% by weight Jayflex® MB 10 and 33% by weight Hexamoll®DINCH®. As a comparison, PVC plastisols were also produced comprising, as plasticizer, exclusively Hexamoll® DINCH®, Palatinol® N or tri(isobutyl) 1,2,4-benzenetricarboxylate (compound I.4). For the tests here however, a preflim was not firstly produced but rather the plastisol was gelled directly at 190° C. for 2 min in the Mathis oven. The test of the film volatility was carried out on the ca. 0.5 mm thick films thus produced.

Test of the film volatility at 130° C. over 24 h:

To determine the film volatility, four single films (150×100 mm) were cut out, punched and weighed from the plastisols gelled at 190° C. for 2 min. The films were suspended on a rotating star in a Heraeus drying cabinet type 5042 E set to 130° C. The air in the cabinet was ex-changed 18 times per hour. This corresponds to 800 l/h of fresh air. After 24 h in the cabinet, the films were removed and reweighed. The weight loss in percent gives the film volatility of the plasticizer compositions.

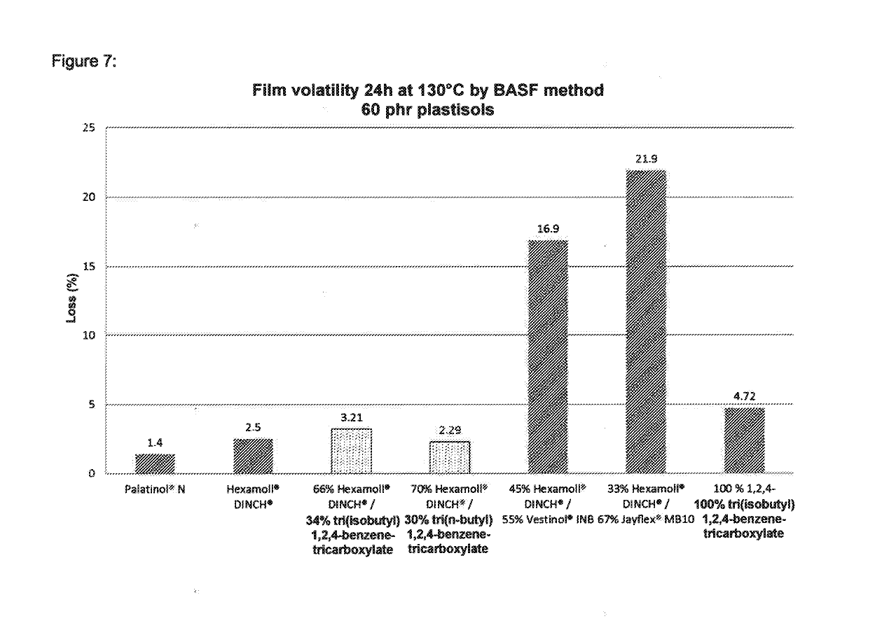

As is very readily apparent from FIG. 7, the film volatility of the disclosed plasticizer composition composed of 30% by weight compound I.3 and 70% by weight Hexamoll® DINCH® or 34% by weight compound I.4 and 66% by weight Hexamoll®DINCH® is distinctly lower than the film volatility of the plasticizer compositions composed of 55% by weight Vestinol® INB and 45% by weight Hexamoll®DINCH® and also 67% by weight Jayflex® MB 10 and 33% by weight Hexamoll®DINCH®.

The film volatility of the disclosed plasticizer composition composed of 30% by weight compound 1.3 and 70% by weight Hexamoll® DINCH® or 34% by weight compound I.4 and 66% by weight Hexamoll® DINCH® is however higher than that of the pure plasticizer Palatinol® N, but distinctly lower than that of pure tri(isobutyl) 1,2,4-benzenetricarboxylate (compound I.4).

II.f) Determination of the Compatibility (Permanence) of Films of Plastisols with the Plasticizer Compositions According to the Disclosure

To test the compatibility, plastisols were produced as described in II.c) with the disclosed plasticizer composition composed of 30% by weight compound I.3 and 70% by weight Hexamoll® DINCH® or 34% by weight compound I.4 and 66% by weight Hexamoll®DINCH® and plastisols with the plasticizer compositions composed of 55% by weight Vestinol® INB and 45% by weight Hexamoll®DINCH® and also 67% by weight Jayflex® MB 10 and 33% by weight Hexamoll®DINCH®. As a comparison, plastisols were also produced comprising, as plasticizer, exclusively Hexamoll®DINCH®, Palatinol® N or tri(isobutyl) 1,2,4-benzenetricarboxylate (compound 1.4). For the tests here however, a prefilm was not firstly produced but rather the plastisol was gelled directly at 190° C. for 2 min in the Mathis oven. The test of the compatibility was carried out on the ca. 0.5 mm thick films thus produced.

Test Method:

Purpose of the Test Procedure:

The test provides the qualitative and quantitative measurement of the compatibility of soft PVC formulae. It is conducted at elevated temperature (70° C.) and humidity (100% rel. h). The data obtained are evaluated against storage time.

Specimens

For the standard test, 10 specimens (films) of size 75×110×0.5 mm were used for each formulation. The films were punched, labeled and weighed on the width side. The labelling must be indelible and can be done, for example, using a soldering iron.

Test Equipment

Heating cabinet, analytical balance, temperature measuring equipment with sensors for measuring the temperature of the interior space of the heating cabinet, glass beakers, metal racks made of rust-proof material;

Test temperature: 70° C.

Test medium: steam formed at 70° C. from completely demineralized water

Procedure:

The temperature in the interior space of the heating cabinet was adjusted to the required 70° C.

The test films were suspended on a wire frame and placed in a glass bowl which had been filled to a height of 5 cm with water (demin. water). Only films of identical composition must be stored in a labeled and numbered beaker in order to avoid mutual Interference and to simplify withdrawal after the respective storage times.

The glass bowl was sealed with a PE film impervious to water vapor, so that the water vapor formed in the glass bowl could not escape.

Storage Time

In a 1, 3, 7, 14 and 28 day rhythm, 2 films (duplicate determination) In each case were removed from the glass bowl and climatized freely suspended in air for 1 hour. Subsequently, the films were cleaned with methanol in the fume hood (tissues moistened with methanol). The films were then dried freely suspended in a drying cabinet (natural convection) at 70° C. for 16 h. After removal from the drying cabinet, the films were conditioned freely suspended in the laboratory for 1 hour and then weighed. The test result was specified in each case as the arithmetic mean of the weight changes of the samples prior to Introduction to the heating cabinet.

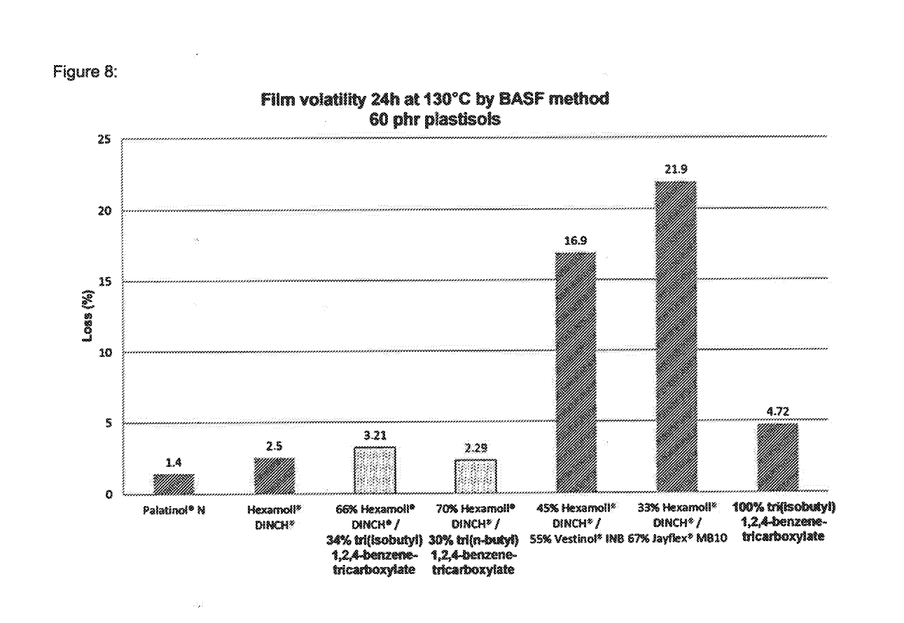

As is very readily apparent from FIG. 8, the exudation characteristics of the plasticizer composition disclosed, composed of 30% by weight compound I.3 and 70% by weight Hexamoll®DINCH® or 34% by weight compound I.4 and 66% by weight Hexamoll®DINCH® are distinctly better than the exudation characteristics of the plasticizer compositions composed of 55% by weight Vestinol® INB and 45% by weight Hexamoll®DINCH® and also 67% by weight Jayflex® MB 10 and 33% by weight Hexamoll®DINCH®. The compatibility of the plasticizer composition disclosed is accordingly better than the compatibility of the plasticizer compositions composed of 55% by weight Vestinol® INB and 45% by weight Hexamoll®DINCH® and also 67% by weight Jayflex® MB 10 and 33% by weight Hexamoll® DINCH®. The exudation characteristics of the plasticizer composition disclosed are however worse than the exudation characteristics of the pure plasticizers Hexamoll® DINCH® and Palatinol® N, but better than that of tri(isobutyl) 1,2,4-benzenetricarboxylate (compound I.4).

III. Comparative Experiments for Volatility of Trialkyl Trimellitates

Trialkyl trimellitates, differing in the number of carbon atoms in their alkyl chains, were investigated with respect to their process volatility and film volatility. The process volatility was determined in analogy to II. c), the film volatility determined in analogy to II. e). Plastisols with the following formulations were used:

| | phr |
|---|---|
| PVC (mixture of 70 parts by weight homopolymeric emulsion | 100 |
| PVC Solvin ® 367 NC and 30 parts by weight homopolymeric | |
| emulsion PVC Vinnolit ® P 70) | |
| Tri-n-butyl trimellitate (TBTM) | 60 |
| Ba—Zn Stabilizer, Reagent SLX/781 | 2 |

| | phr |
|---|---|
| PVC (mixture of 70 parts by weight homopolymeric emulsion | 100 |
| PVC Solvin ® 367 NC and 30 parts by weight homopolymeric | |
| emulsion PVC Vinnolit ® P 70) | |
| Trimethyl trimellitate (TBTM) | 60 |
| Ba—Zn Stabilizer, Reagent SLX/781 | 2 |

| | Trimethyl trimellitate | Tributyl trimellitate |
|---|---|---|
| Process volatility [%] | 5.9 | 1.4 |
| Film volatility [%] | 26 | 2 |
| Overall volatility [%] | 32 | 3.4 |

The comparison shows that TMTM has higher volatility than TBTM.

1. A plasticizer composition comprising
(a) at least one compound of the general formula (I), 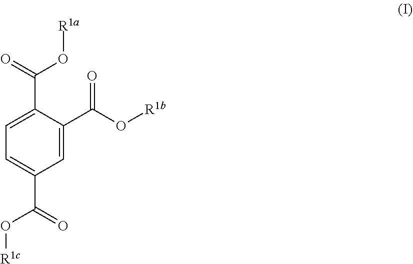
in which
R^{1a} R^{1b} and R^{1c} are each independently C₃- to C₅-alkyl and
(b) at least one compound of the general formula (II), 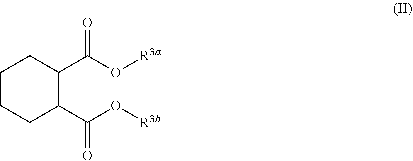
in which
R^{2a} and R^{2b} are each independently C₇- to C₁₂-alkyl.

2. The plasticizer composition according to claim 1, wherein in the at least one compound of the general formula (I) present, R^{1a}, R^{1b} and R^{1c} are each independently n-propyl, isopropyl, n-butyl, isobutyl, n-pentyl, 2-methylbutyl or 3-methylbutyl.

3. The plasticizer composition according to claim 1, wherein in the at least one compound of the general formula (II) present, R^{2a} and R^{2b} are 2-ethylhexyl, isononyl or 2-propylheptyl.

4. The plasticizer composition according to claim 1, wherein the plasticizer composition comprises at least one plasticizer, which is different from the compounds of the general formula (I) and (II).

5. A molding composition comprising at least one polymer and a plasticizer composition according to claim 1.

6. The molding composition according to claim 5, wherein the at least one polymer present is a thermoplastic.

7. The molding composition according to claim 6, wherein the at least one thermoplastic present is selected from the group consisting of polyvinyl chloride (PVC), polyvinyl butyral (PVB), homo- and/or copolymers of vinyl acetate, homo- and/or copolymers of styrene, polyacrylate, thermoplastic polyurethane (TPU) and polysulfide.

8. The molding composition according to claim 5, wherein the at least one polymer present is an elastomer, and the elastomer is selected from the group consisting of natural rubber and synthetic rubber.

9. A plastisol comprising at least one polymer and the plasticizer composition according to claim 1.

10. The plastisol according to claim 9, wherein the at least one polymer present is a thermoplastic.

11. The plastisol according to claim 9, wherein the at least one polymer present is polyvinyl chloride.

12. (canceled)

13. (canceled)

14. (canceled)

15. The use of a molding composition according to claim 5 for producing moldings and films which come directly into contact with humans or foodstuffs.

16. The use of a plastisol according to claim 9 for producing films, wallpaper, seamless hollow bodies, gloves, seals, gaskets, cladding or console covers in vehicles, dolls, game pieces or modelling clays, inflatable toys such as balls or rings, slipper socks, swimming aids, diaper-changing pads, gymnastic balls, exercise mats, seat cushions, vibrators, massage balls or rollers, latex clothing, protective clothing, rain jackets or rubber boots or coatings.

17. The molding or film comprising the plasticizer composition according to claim 1.
